(19) United States
(12) Patent Application Publication
(10) Pub. No.: US 2007/0061438 A1
(43) Pub. Date: Mar. 15, 2007

(54) Communication control device, communication control method, communication control program, and storage medium

(76) Inventor: Tsutomu Yuki, Tokyo (JP)

Correspondence Address: DICKSTEIN SHAPIRO LLP, 1825 EYE STREET NW, Washington, DC, 20006-5403, US

(21) Appl. No.: 11/518,191

(22) Filed: Sep. 11, 2006

(30) Foreign Application Priority Data
Sep. 9, 2005 (JP) 2005-261622
Sep. 9, 2005 (JP) 2005-261623
Sep. 16, 2005 (JP) 2005-270669
Sep. 6, 2006 (JP) 2006-240976

(51) Int. Cl. G06F 15/173

(52) U.S. Cl. 709/223

(57) ABSTRACT

A communication control device includes a communication control interface which performs a communication control adapted for an application program. A common information ID control part performs management and control of a common information ID. A common information ID XML file stores information of the common information ID. A protocol control part performs management and control of each protocol ID and a communication control of a protocol. A protocol information ID XML file stores information of an information ID for each protocol. A communication library performs a communication control with an external device. A control unit controls the whole communication control device.

### BACKGROUND OF THE INVENTION

1. Field of the Invention

This invention relates to a communication control device, a communication control method, a communication control program, and a storage medium which are adapted to carry out communication using the same communication device and two or more different protocols.

2. Description of the Related Art

Conventionally, communication control is carried out using the SNMP (Simple Network Management Protocol) as the mechanism for performing the status monitoring of, the setting control to and the acquisition of information from a device connected to a network, from a PC (Personal Computer) via the network.

In recent years, protocols other than SNMP also have come to be capable of performing the status monitoring of, the setting control to and the acquisition of information from a device connected to a network. For example, when information is acquired from the device connected to the network by the PC using the device management software, the device information can be acquired using a message in XML (Extensible Markup Language) form like SOAP (Simple Object Access Protocol). For example, see Japanese Laid-Open Patent Application No. 2004-537091.

Moreover, there has been proposed a communication control device which is connected via a network to a device adapted to perform communication, and comprises a communication management unit. According to this communication management unit of the communication control device, an inquiry as to whether the device is adapted to perform communication using the protocol supported by the communication control device is sent to the device. When it is determined based on a response from the device in replay to the inquiry that the device is not adapted to perform communication using the protocol, a communication mechanism for performing communication using the protocol, from an external device connected to the network is downloaded to the device. And the communication management unit communicates with the device using the communication mechanism. For example, see Japanese Laid-Open Patent Application No. 2005-204279.

However, the conventional method has a problem that, when an application program accesses a device to acquire an information item from the device to carry out setting of information to the device, it is uncertain which communication protocol should be used to perform communication control.

In the case of the conventional method disclosed in Japanese Laid-Open Patent Application No. 2005-204279, when it is determined that the device is not adapted to perform communication using the supported protocol, it is necessary to download the communication mechanism from the external device connected to the network. Such communication control may be complicated, and the processing for downloading it takes a long time.

Moreover, in the case of the conventional method disclosed in Japanese Laid-Open Patent Application No. 2004-537091, when acquiring the device information using the XML form message, the contents of the description can be defined in the message. However, since the contents of XML data are manufacture dependent or model dependent, the commonization is not necessarily guaranteed.

Moreover, when the message data is a character string, the XML data file for acquiring the device information using the SOAP is fundamentally UTF-8 (8-bit UCS Transformation Format) code. On the other hand, in the case of the SNMP, the language-specific character code (for example, “Shift JIS” character code in the case of Japanese) is used. The system of the character code depending on the protocol for acquiring the device information is also protocol dependent. For this reason, the user who uses the application program concerned must consider the difference in the character codes as the number of communication protocols used increases.

### SUMMARY OF THE INVENTION

According to one aspect of the invention, there is provided an improved communication control device and method in which the above-described problems are eliminated.

According to one aspect of the invention there is provided any of a communication control device, a communication control method, a communication control program, and a storage medium which are adapted to ease the burdens of an application program when carrying out communication with an image forming device or information processing device.

In an embodiment of the invention which solves or reduces one or more of the above-mentioned problems, there is provided a communication control device comprising: a communication control interface performing a communication control adapted for an application program; a common information ID control part performing management and control of a common information ID; a common information ID XML file storing information of the common information ID; a protocol control part performing management and control of each protocol ID and a communication control of a protocol; a protocol information ID XML file storing information of an information ID for each protocol; a communication library performing a communication control with an external device; and a control unit controlling the whole communication control device.

In an embodiment of the invention which solves or reduces one or more of the above-mentioned problems, there is provided a communication control method for use in a communication control device including a communication control interface performing a communication control for each application program, a common information ID control part performing management and control of a common information ID, a common information ID XML file storing information of the common information ID, a protocol control part performing management and control of each protocol ID and a communication control of a protocol, a protocol information ID XML file storing information of an information ID for each protocol, a communication library performing a communication control with an external device, and a control unit controlling the whole communication control device, the communication control method comprising the steps of: receiving an information ID specified by the application program as information being acquired from the device, when a protocol is predetermined; detecting whether the specified information ID is registered in the protocol information ID XML file; and acquiring information of the specified information ID from the protocol information ID XML file when the specified information ID is registered, so that a communication processing with the device is performed according to the information ID.

In an embodiment of the invention which solves or reduces one or more of the above-mentioned problems, there is provided a communication control device which is adapted to perform communication using a communication device and a plurality of protocols, comprising: a common information ID control part performing management and control of identification information common to each protocol; and a data-type management part performing management of a data type specific to each protocol, wherein, when a request for connection with the communication device sent from an application program by specifying identification information of a protocol is received, the common information ID control part accesses the communication device by using the protocol corresponding to the specified identification information, acquires device information from the communication device, and returns a result of processing of the device information by the data-type management part, to the application program.

In an embodiment of the invention which solves or reduces one or more of the above-mentioned problems, there is provided a computer-readable program which, when executed by a computer, causes the computer to perform a communication control method for use in a communication control device adapted to perform communication using a communication device and a plurality of protocols, the communication control device including a common information ID control part performing management and control of identification information common to each protocol, and a data-type management part performing management of a data type specific to each protocol, the communication control method comprising the steps of: accessing, when a request for connection with the communication device sent from an application program by specifying identification information of a protocol is received at the common information ID control part, the communication device by using the protocol corresponding to the specified identification information; acquiring device information from the communication device; and returning a result of processing of the device information by the data-type management part, to the application program.

According to embodiments of the communication control device and method of the invention, it is possible to ease the burdens of an application program when carrying out communication with an image forming device or information processing device.

### BRIEF DESCRIPTION OF THE DRAWINGS

Other objects, features and advantages of the present invention will be apparent from the following detailed description when reading in conjunction with the accompanying drawings.

FIG. 1 is a diagram showing the composition of the network system concerning the embodiment 1 of the invention.

FIG. 2A is a diagram showing the composition of the image forming device concerning the embodiment 1 of the invention.

FIG. 2B is a diagram showing the composition of the information processing device concerning the embodiment 1 of the invention.

FIG. 3 is a diagram showing the principal part of the software composition in the information processing device concerning the embodiment 1 of the invention.

FIG. 4 is a diagram showing the detailed composition of the network layer concerning the embodiment 1 of the invention.

FIG. 5 is a diagram showing an example of the category of the device information concerning the embodiment 1 of the invention.

FIG. 6 is a diagram showing the functional composition of the communication control function concerning the embodiment 1 of the invention.

FIG. 7 is a diagram showing an example of the XML file of the access method concerning the embodiment 1 of the invention.

FIG. 8 is a diagram showing an example of the common information ID definition file related to the device name concerning the embodiment 1 of the invention.

FIG. 9A is a flowchart for explaining DeviceOpen( ) in the communication control function (when information ID is adapted to specify protocol information ID) concerning the embodiment 1 of the invention.

FIG. 9B is a flowchart for explaining DeviceGet( ) in the communication control function (when information ID is adapted to specify protocol information ID) concerning the embodiment 1 of the invention.

FIG. 9C is a flowchart for explaining DeviceClose( ) in the communication control function (when information ID is adapted to specify protocol information ID) concerning the embodiment 1 of the invention.

FIG. 9D is a flowchart for explaining the protocol-specific communication processing in the communication control function (when information ID is adapted specify protocol information ID) concerning the embodiment 1 of the invention.

FIG. 10A is a flowchart for explaining DeviceOpen( ) in the communication control function (when information ID is adapted to specify both common information ID and protocol information ID) concerning the embodiment 1 of the invention.

FIG. 10B is a flowchart for explaining DeviceGet( ) in the communication control function (when information ID is adapted to specify both common information ID and protocol information ID) concerning the embodiment 1 of the invention.

FIG. 10C is a flowchart for explaining DeviceClose( ) in the communication control function (when information ID is adapted to specify both common information ID and protocol information ID) concerning the embodiment 1 of the invention.

FIG. 10D is a flowchart for explaining the protocol-specific communication processing in the communication control function (when information ID is adapted to specify both common information ID and protocol information ID) concerning the embodiment 1 of the invention.

FIG. 11 is a sequence diagram for explaining an example of the procedure of the communication control function (when information ID is adapted to specify protocol information ID) concerning the embodiment 1 of the invention.

FIG. 12 is a sequence diagram for explaining an example of the procedure of the communication control function (when information ID is adapted to specify both common information ID and protocol information ID) concerning the embodiment 1 of the invention.

FIG. 13 is a diagram showing the functional composition of the communication control function concerning the embodiment 2 of the invention.

FIG. 14A is a diagram showing an example of the common information ID definition file related to the toner concerning the embodiment 2 of the invention.

FIG. 14B is a diagram showing an example of the data file for data-type conversion concerning the embodiment 2 of the invention.

FIG. 15 is a flowchart for explaining DeviceGet( ) in the communication control function concerning the embodiment 2 of the invention.

FIG. 16 is a flowchart for explaining data-type conversion processing in the communication control function concerning the embodiment 2 of the invention.

FIG. 17 is a sequence diagram showing an example of the procedure of the communication control function concerning the embodiment 2 of the invention.

FIG. 18 is a diagram showing the functional composition of the communication control function concerning the embodiment 3 of the invention.

FIG. 19 is a flowchart for explaining data-type conversion processing in the communication control function concerning the embodiment 3 of the invention.

FIG. 20 is a flowchart for explaining SetCharCode( ) in the communication control function concerning the embodiment 3 of the invention.

FIG. 21 is a flowchart for explaining character code conversion processing in the communication control function concerning the embodiment 3 of the invention.

FIG. 22 is a sequence diagram for explaining an example of the procedure of the communication control function concerning the embodiment 3 of the invention.

FIG. 23 is a diagram showing the composition of the network layer concerning the embodiment 4 of the invention.

FIG. 24 is a diagram showing the functional composition of the communication control function concerning the embodiment 4 of the invention.

FIG. 25A is a diagram showing an example of the common information ID definition file related to the character code concerning the embodiment 4 of the invention.

FIG. 25B is a diagram showing an example of the data file for unified character code conversion concerning the embodiment 4 of the invention.

FIG. 26 is a flowchart for explaining DeviceGet( ) in the communication control function concerning the embodiment 4 of the invention.

FIG. 27 is a flowchart for explaining unified character code conversion processing in the communication control function concerning the embodiment 4 of the invention.

FIG. 28 is a sequence diagram for explaining an example of the procedure of the communication control function concerning the embodiment 4 of the invention.

FIG. 29 is a diagram showing the functional composition of the communication control function concerning the embodiment 5 of the invention.

FIG. 30 is a flowchart for explaining DeviceGet( ) in the communication control function concerning the embodiment 5 of the invention.

FIG. 31 is a flowchart for explaining the character code analysis processing in the communication control function concerning the embodiment 5 of the invention.

FIG. 32 is a sequence diagram for explaining an example of the procedure of the communication control function concerning the embodiment 5 of the invention.

FIG. 33 is a diagram showing the functional composition of the communication control function concerning the embodiment 6 of the invention.

FIG. 34 is a sequence diagram for explaining an example of the procedure of the communication control function concerning the embodiment 6 of the invention.

### DETAILED DESCRIPTION OF PREFERRED EMBODIMENTS

A description will be given of embodiments of the invention with reference to the accompanying drawings.

### Embodiment 1

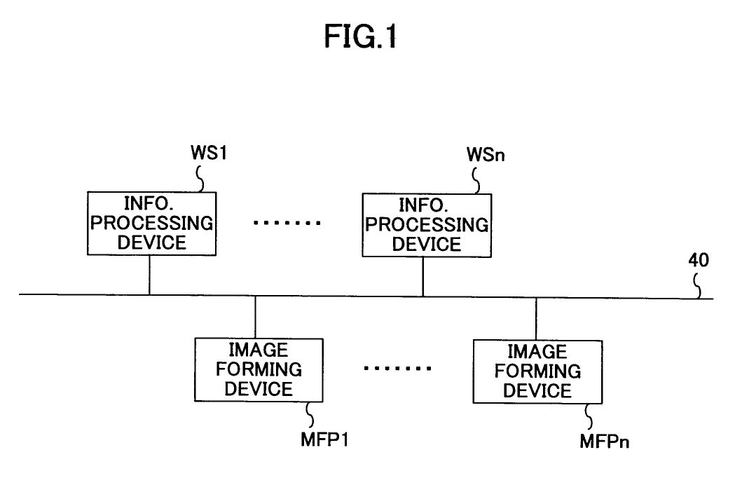

FIG. 1 shows the composition of a network system concerning the embodiment 1 of the invention.

In this network system, a plurality of information processing devices WS1-WSn and a plurality of image forming devices MFP1-MFPn are connected to a local area network LAN 40.

Each of the image forming devices MFP1-MFPn is provided with a communication control device, and have two or more image formation functions, such as a network scanner function, a network printer function, and a copy function.

Communication using one or more communication protocols is possible for each image forming device MFP1-MFPn.

The protocols implemented may differ in the plurality of image forming devices MFP1-MFPn.

Information processing devices WS1-WSn are provided with a communication control device, and it has a local-data processing facility and a network computation function.

It also has the communication facility of printing out the document drawn up locally from image forming device MFP1-MFPn via a local area network LAN (Local Area Network) 40 (LAN 40).

Peripheral-device management software is implemented in each of the information processing devices WS1-WSn, so that the implemented software of the information processing device acquires various items of device information from any of the image forming devices MFP1-MFPn.

The user of each of the information processing devices WS1-WSn can collect suitably the device information of image forming device MFP1-MFPn connected to the LAN 40 using the peripheral-device management software.

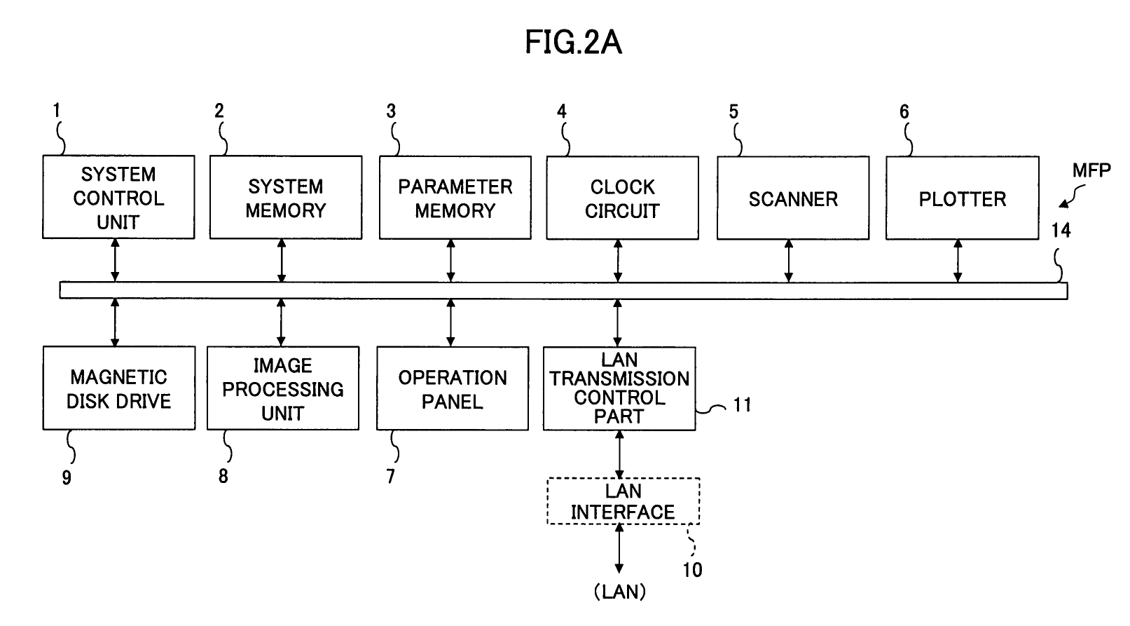

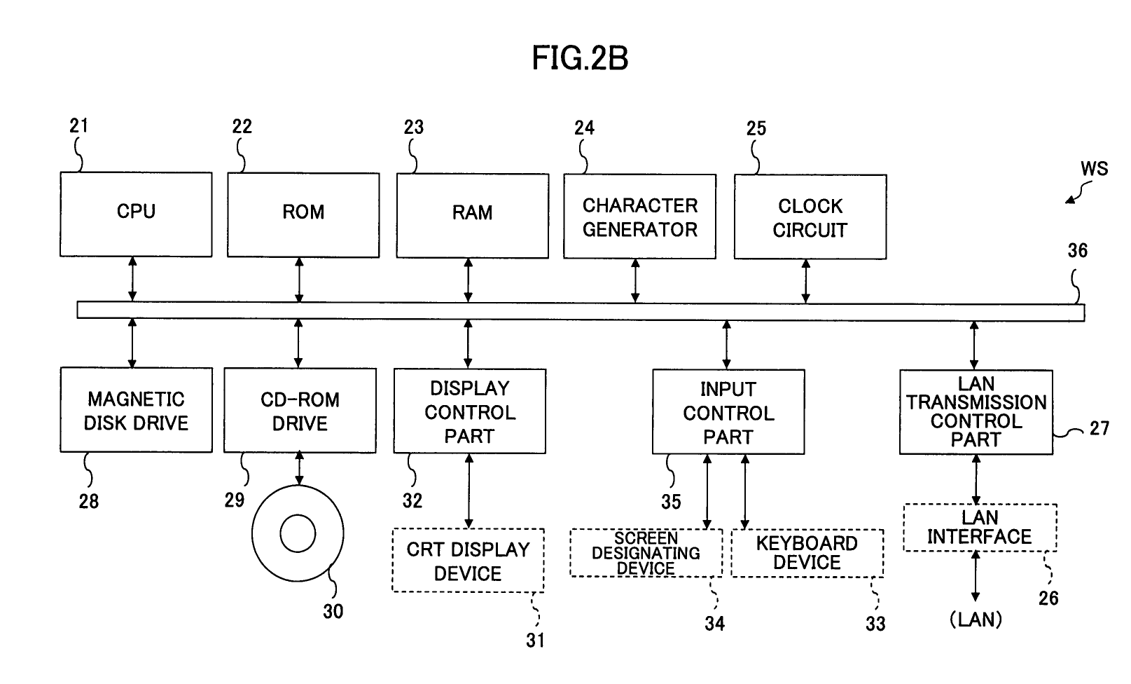

FIG. 2A shows the composition of the image forming device MFP (MFP1-MFPn) concerning the embodiment 1 of the invention.

As shown in FIG. 2A, system control unit 1 performs various control processings, such as this image forming device MFP1—control processing of each part of MFPn, and communication processing.

It constitutes the work area of system control unit 1 while memorizing required various data etc., when system memory's 2 executing the control processing program which system control unit 1 executes, and a processing program.

Parameter memory 3 is a device for memorizing various kinds of information specific to this image forming device MFP1-MFPn. Clock circuit 4 outputs information of the current time.

Scanner 5 is a device for reading a document image in a predetermined resolution.

Plotter 6 is a device for printing and outputting an image in a predetermined resolution.

Operation panel 7 is a device for operating this image forming device MFP1-MFPn, and includes various kinds of operation keys and various kinds of display indicators.

Image processing unit 8 applies various image processings related to the image data read and obtained with scanner 5.

Magnetic disk drive 9 stores various files, such as image data and various program files. LAN interface unit 10 connects this image forming device MFP1-MFPn to LAN 40.

LAN transmission control part 11 performs various communication control processings of the predetermined protocol for exchanging various data among other data terminal device via the LAN 40.

The system control units 1, the system memory 2, the parameter memory 3, the clock circuit 4, the scanner 5, the plotter 6, the operation panel 7, the image processing unit 8, the magnetic disk drive 9, and the LAN transmission control part 10 are connected to internal bus 14, and the exchange of data between two of these elements is performed through the internal bus 14.

FIG. 2B shows the composition of the information processing device WS (WS1-WSn) concerning the embodiment 1 of the invention. As shown in FIG. 2B, CPU (Central Processing Unit) 21 performs motion control of these information processing devices WS1-WSn.

ROM (Read Only Memory) 22 stores a program, required data, etc. which the CPU 21 performs at the time of starting. RAM (Random Access Memory) 23 constitutes the work area of the CPU 21. Character generator 24 generates the indicative data of the graphic character. Clock circuit 25 outputs information of the current date and time. LAN interface circuit 26 connects each of the information processing devices WS1-WSn to the LAN 40. LAN transmission control part 27 performs various communication control processings of the predetermined protocol for exchanging various data among other data terminal device via the LAN 40.

Magnetic disk drive 28 stores the various data of system software (operating system), various application programs, work data, file data, drawing information data, etc. CD-ROM (Compact Disk Read Only Memory) drive 29 reads the data of CD-ROM 30 which is a removable storage medium. CRT (Cathode Ray Tube) display device 31 displays the display screen for operating the information processing device WS1-WSn. Display control part 32 controls the contents of a display of CRT display device 31. Keyboard device 33 inputs the input data based on various key strokes into these information processing devices WS1-WSn. Screen designating device 34 is a device for performing operation of directing the arbitrary points of CRT display device 31. Input control part 35 performs control for capturing the input information of keyboard device 33 and screen designating device 34.

The CPU 21, the ROM 22, the RAM 23, the character generator 24, the clock circuit 25, the LAN transmission control part 27, the magnetic disk drive 28, the CD-ROM drive 29, the display control part 32, and the input control part 35 are connected to an internal bus 36, and the exchange of data between two of these elements is performed through the internal bus 36.

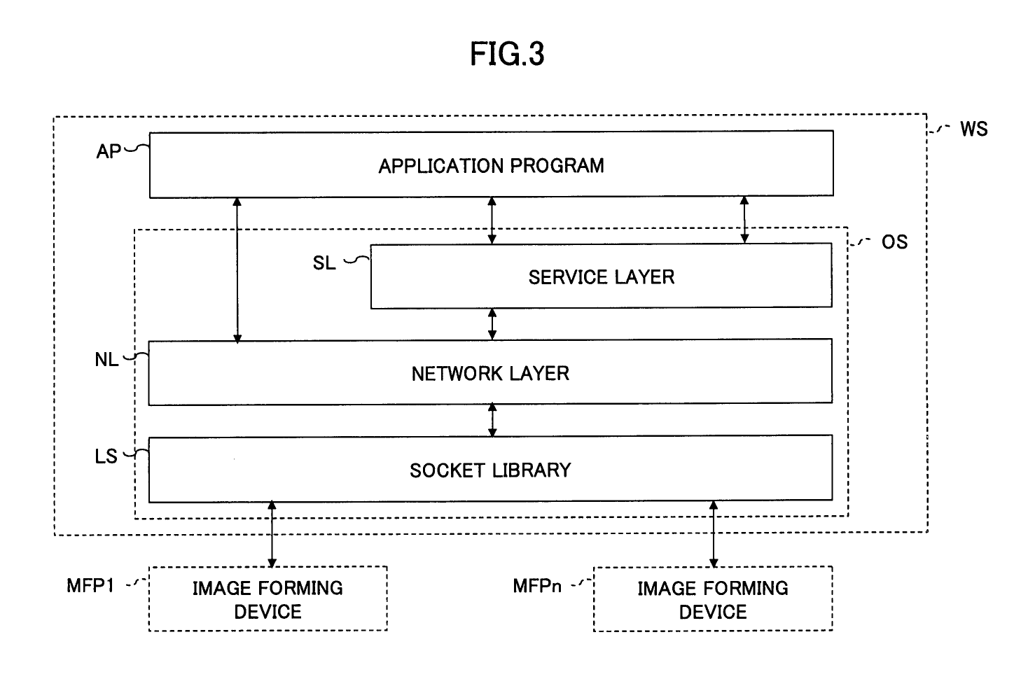

FIG. 3 shows the software composition of the information processing device WS (WS1-WSn) concerning the embodiment 1 of the invention.

Application program AP realizes various functions through the operating system OS (Operating System) for carrying out supervisory control of the system.

The application program AP is the software which is used by the user directly. For example, it is a peripheral-device management system (software) of displaying the state of image forming device MFP1-MFPn connected on a network.

Service layer SL, network-layer NL, and socket library LS are provided in operating system OS. Service layer SL is the group which collected services (library) of the log server service which manages the DB server service which manages the information, including device management service, device information, log information, etc., that a device and a device are managed, by DB (database), and a log output.

Network layer NL is the library provided with functions, such as communication control with a device, protocol management, and device search. Socket library LS is a library (communication library) which mainly offered control and the procedure of TCP/IP network communication as interface in the application corresponding to a network.

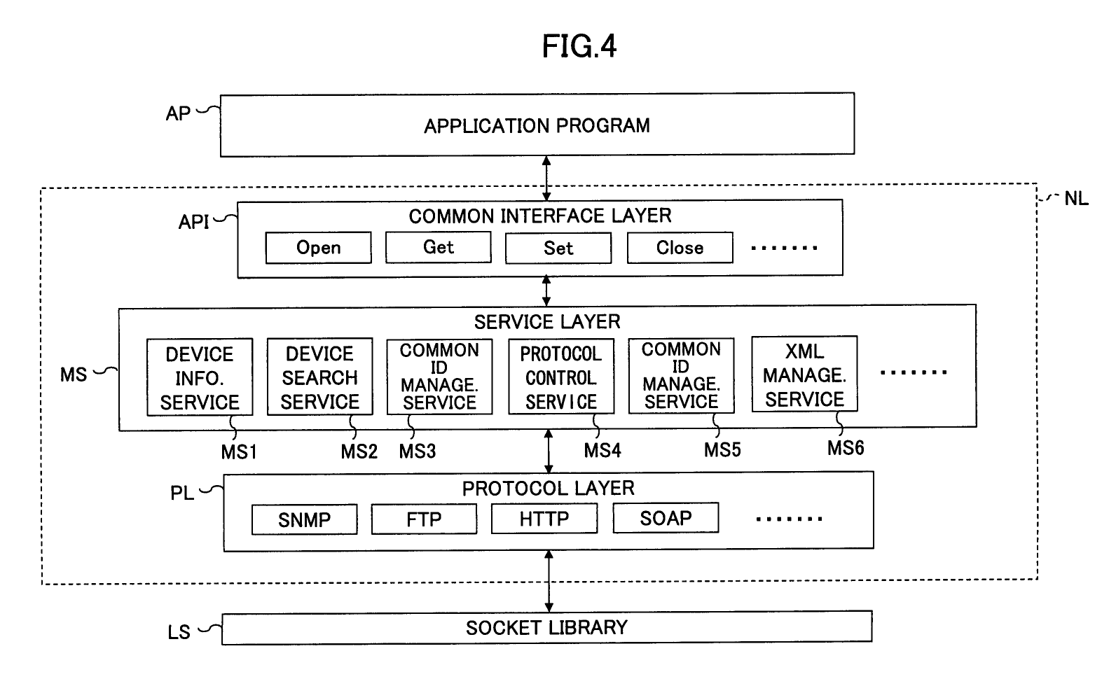

FIG. 4 shows the detailed composition of the network layer NL concerning the embodiment 1 of the invention.

The network-layer NL is a layer in which the function for offering communication facility (acquisition, a setup, etc. of information) with a device to the application program AP is implemented, and includes a common interface (common API) layer, a service layer, and a protocol layer.

Common interface (common API) layer API is a layer in which API (Application Program Interface) which offers the abstract interface independent of the classification of the information acquired from a device etc. to the application program AP is implemented.

For example, the function (Open) for starting communication with a device, the function (Get) for acquiring information from device 20, the function (Set) for setting information to device 20, the function (Close) for ending communication with device 20, etc. are implemented.

Each function in common API layer 13 calls a service layer based on the abstract parameters (classification of information to acquire etc.) given from application program AP, and the parameters (time-out etc.) for controlling communication.

Service layer MS is constituted by the module group which offers the function which specialized in each service, such as device information service MS1, device search service MS2, trap service MS3, protocol control service MS4, common ID management service MS5, and XML management service MS6.

The device information service MS1 is a module which offers functions, such as acquisition and setting of various items of information of a device. The device information the acquisition and setting of which are carried out by the device information service MS1 will be explained.

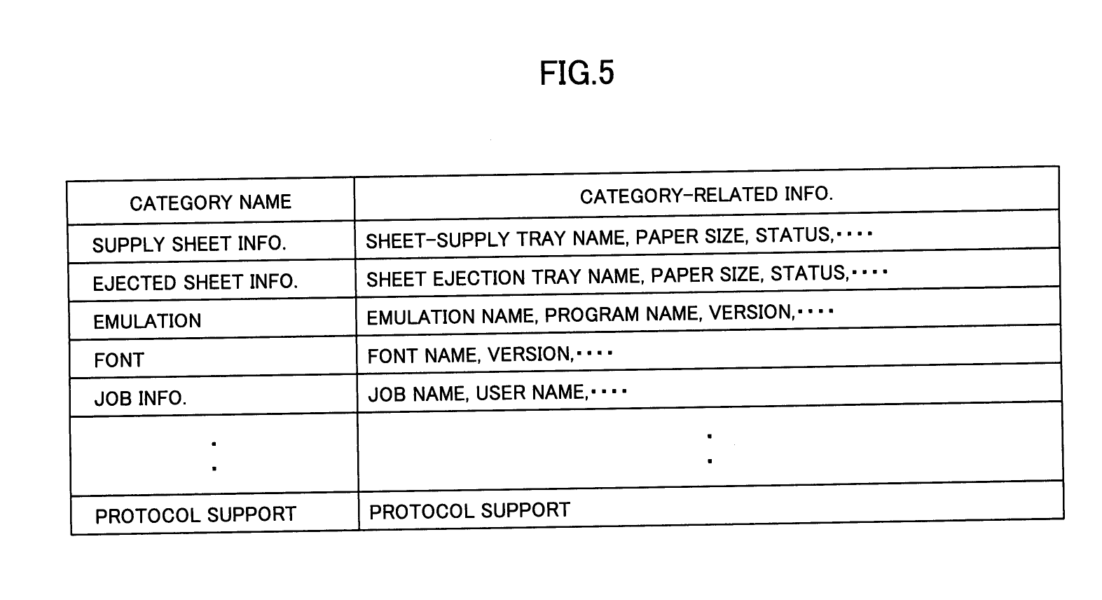

FIG. 5 shows an example of the category of the device information concerning the embodiment 1 of the invention.

Device information can be classified into some categories as shown in FIG. 5.

In FIG. 5, the category name of each category and the information belonging to each category are shown in a tabular form.

For example, as is apparent from FIG. 5, the category of device information includes the information (supply sheet information) related to a sheet-supply tray, the information related to a sheet-ejection tray (ejected sheet information), the information (emulation) related to the emulation currently supported, the information (font) related to the font currently supported, the information (job information) related to a job, the information (protocol support) related to the existence of support of a protocol, etc. It is apparent that information, including a sheet-supply tray name, a paper size, a state, etc., is included in the supply-sheet information.

Referring back to FIG. 4, the device search service MS2 is a module which offers the search service of the device linked to the local area network LAN. The trap service MS3 is a module which offers the functions to receive a trap sent from the device 20 in the SNMP communication with the device, and to notify the received trap (common ID) to the application program AP.

The protocol control service MS4 is a module which manages the information related to the destination in transmission of an e-mail or the like. The common ID management service MS5 is a module which offers the functions to acquire device information through the protocol layer based on the ID request from the application program, and to return the information to the application program.

The protocol control service MS4 is a module which offers the functions to perform ID management of each protocol, control of a protocol, and a communication control of a protocol. The XML management service MS6 is a module which offers the functions to manage an ID of a protocol requested by the application program AP, and the device information associated with the ID by using an XML file, to receive the request from the common ID management service, to retrieve the corresponding information from the XML file being managed, and to return the retrieved information to the common ID management service MS5.

The service layer MS calls the protocol layer based on the parameter given from the application program AP through the common API layer, and on the parameter related to the protocol (which specifies the classification related to the protocol used for communication and the automatic specification).

The protocol layer PL is a layer which provides the upper layer (service layer) with a communication function with the device by the protocol concerned with the interface depending on each protocol. For example, the module for performing communication according to any of SNMP, FTP (File Transfer Protocol), HTTP (HyperText Transfer Protocol), SOAP, etc. is implemented.

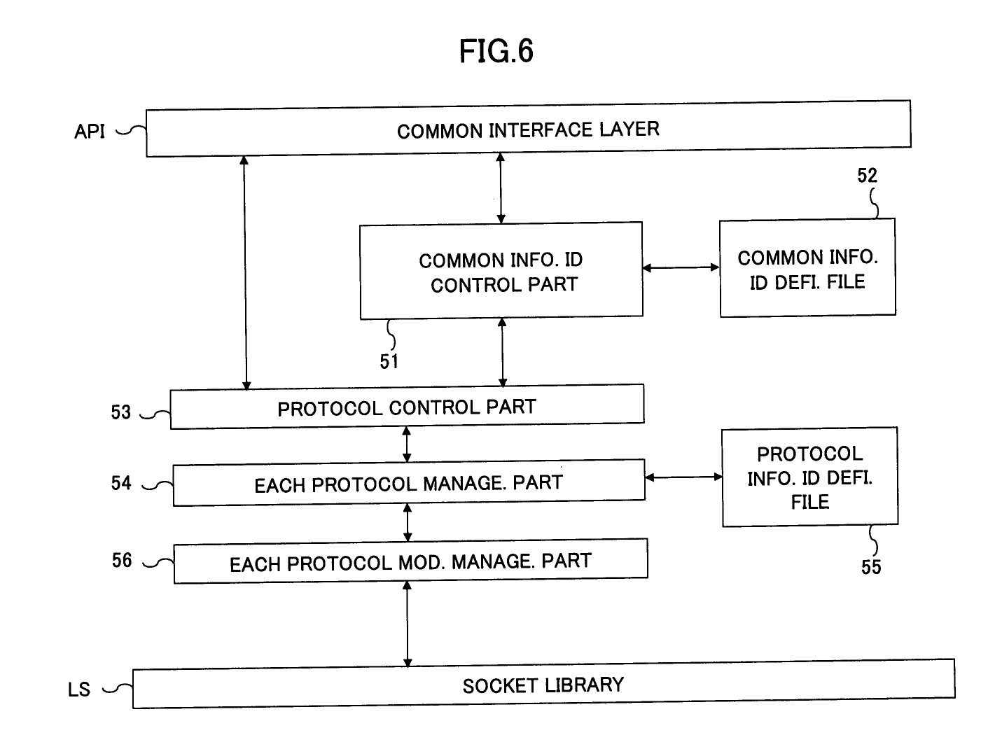

FIG. 6 shows the functional composition of the communication control function concerning the embodiment 1 of the invention.

In this communication control function, a common information ID control part 51 performs management and control of common information ID. A common information ID definition file (common information ID XML file) 52 stores the information of common information ID. A protocol control part 53 performs management and control of each protocol ID, and a communication control of a protocol. Each protocol management part 54 performs management and control of each protocol. A protocol information ID definition file (protocol information ID XML file) 55 stores the information of information ID for each protocol. Each protocol module management part 56 performs control of each protocol.

The communication control function of this embodiment is constituted and aimed at performing a communication control using information ID only, without making the application program conscious of the protocol.

The protocol information ID definition file 55 and the common information ID definition file 52 which store information ID used by the communication control function will be explained.

Information items, such as an information ID name, an access method, a return value, and a control function, are prepared for the protocol information of each protocol, and they are stored in an XML form file (protocol information ID XML file).

For example, in the case of the SNMP protocol, there are provided the following items: information ID name (1), access method (2), return value (3), and internal control function of network-layer NL (4).

(1) information ID name: sheet-supply tray name,

(2) access method: Printer-MIB prtInputName, Printer-MIB prtInputDescription,

(3) return value: string type sheet-supply tray name,

(4) control function: SNMP_GetInputTrayName

The application program specifies protocol name SNMP and specifies the sheet-supply tray name as information ID, when acquiring the device information related to the sheet-supply tray name.

According to the applicable access method (accessing means), within protocol information ID definition file 55, with control function SNMP_GetInputTrayName. The device information related to a sheet-supply tray name is acquired from a device, and the sheet-supply tray name of a string type can be acquired as a return value.

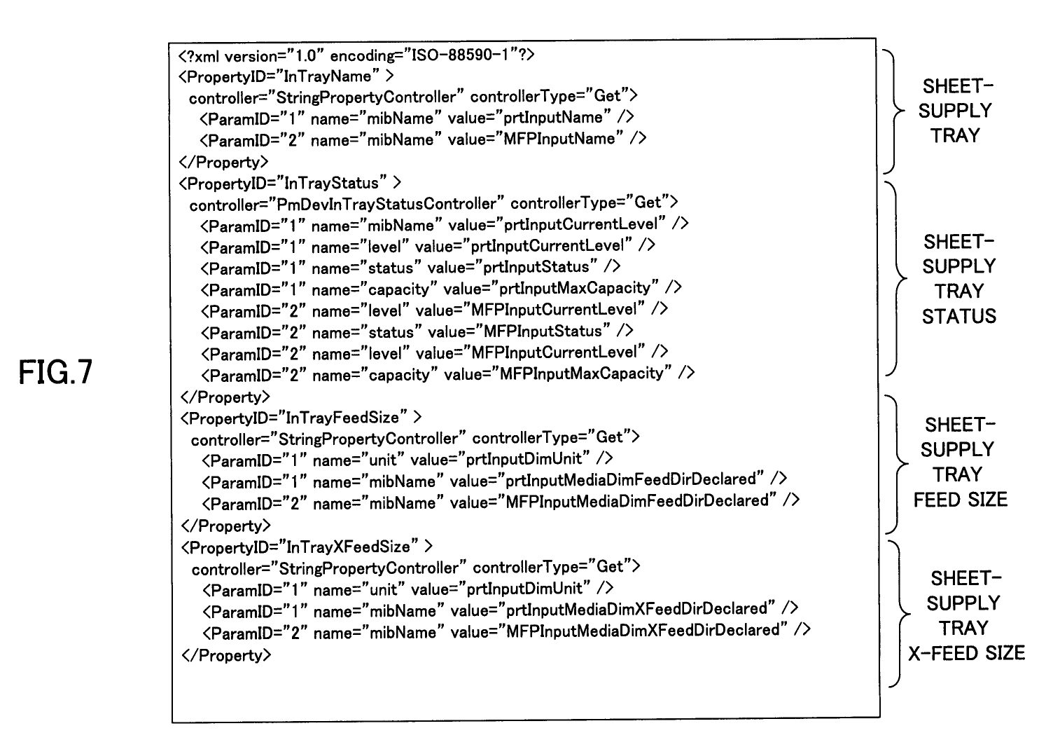

FIG. 7 shows an example of the XML file of the access method concerning the embodiment 1 of the invention.

The procedure for acquiring the information related to the sheet-supply tray in the device information category is defined in FIG. 7.

When a sheet-supply tray name is specified as information ID, according to the access method shown in FIG. 7 applicable to specified information ID, the device information of a sheet-supply tray name is acquired from a device.

When some access methods are in device information to acquire from the device side, it cannot determine which information ID should be used to the device specified by application (when two or more information IDs of the same purpose exist).

In such a case, a burden is placed on application although it is also possible to specify it as plurality. In this invention, the burdens of the application program are eased as follows.

Namely, when there are two or more information IDs of the same purpose, the common information ID (identification information common to each protocol) which is collected as one ID is provided. The item of the control function inside common information ID, information ID of each protocol, a return value, and network-layer NL is prepared, and it is stored by XML form as an XML file (a common information ID XML file and a protocol information ID XML file).

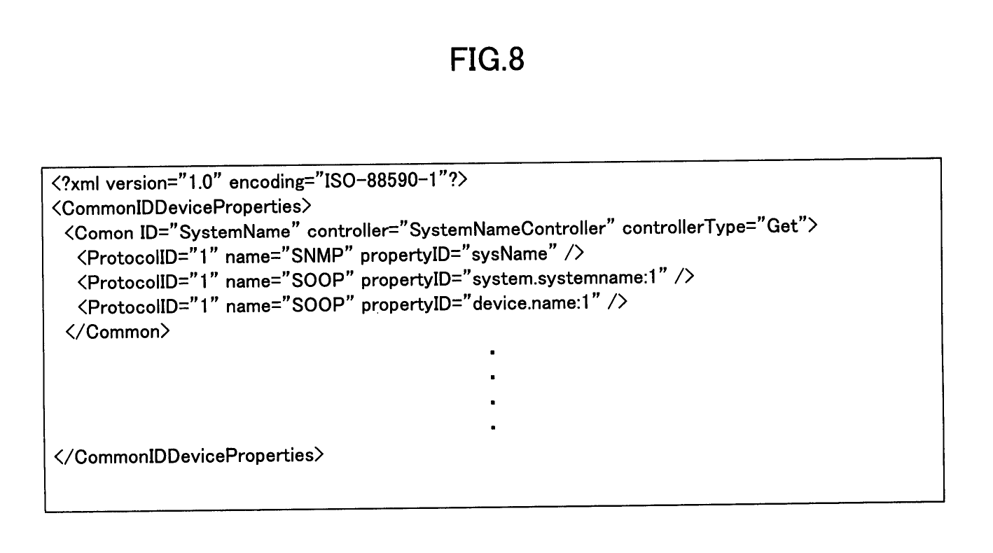

FIG. 8 shows an example of the common information ID definition file 52 related to the device name concerning the embodiment 1 of the invention.

In the case of the common information ID definition file 52 shown in FIG. 7, there are three methods of acquiring the device name: “the method of specifying ID=sysName with an SNMP protocol”, “the method of specifying ID=system.sytemname.:1 by a SOAP protocol”, and “the method of specifying ID=device.name:1 by a SOAP protocol”.

Each acquisition method is defined by this XML file. The application can acquire a device name from a device by specifying a device name (SystemName) as common information ID by three methods shown in FIG. 7, when acquiring the device information related to a device name.

When acquiring a device name from the device side by Web service etc., the contents, such as the parameter concretely specified by Web service, may change with makers.

For example, in the case of A Yashiro, it accesses by “system.systemame:1”, and, in the case of B Yashiro, is a case where it is to access by “device.name:1” etc.

In this embodiment, it is taking into consideration so that several different Web services in this way can also respond. The user sometimes wants to provide a priority in information ID of each protocol indicated to common information ID.

That is, the item of a protocol priority is provided in enabling it to specify even from application, and common information ID.

As the procedure, the priority of a protocol is specified from the application program. Next, a protocol priority parameter is prepared and information ID is searched from a protocol with a high priority at the time of information ID retrieval processing.

And a protocol priority is specified as common information ID, and information ID is searched from a protocol with a high priority specified as common information ID at the time of information ID retrieval processing.

By using such an information ID, an SNMP protocol, a SOAP protocol, etc. can perform communication with a device via two or more protocols and can acquire device information to acquire device information from the device side.

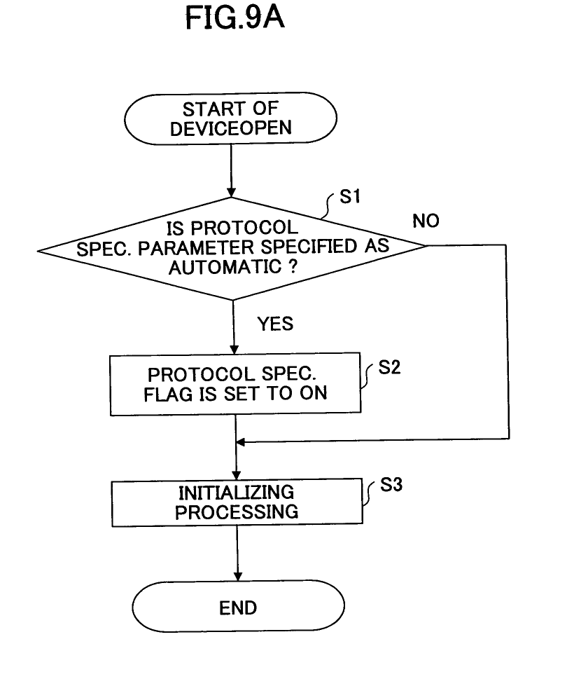

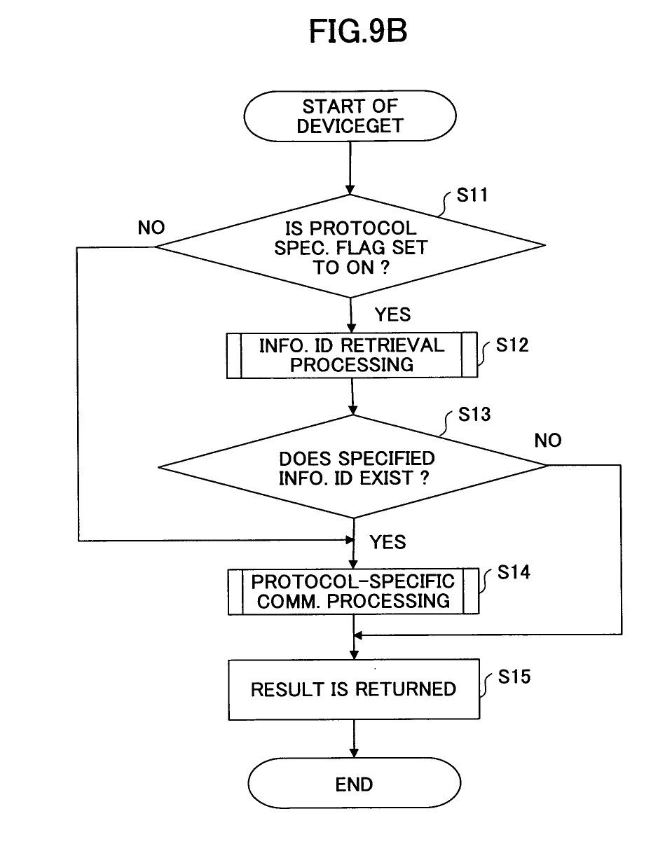

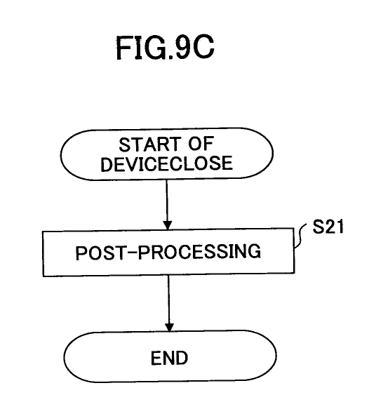

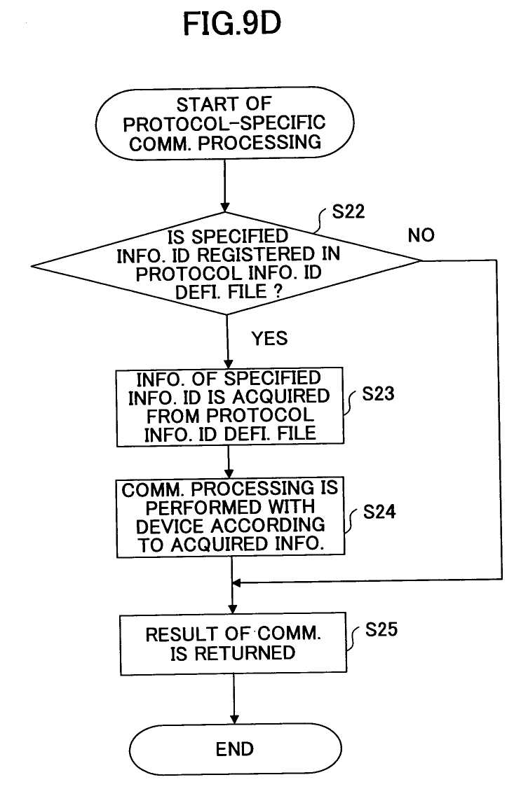

Next, protocol control part 53, each protocol management part 54, and each protocol module management part 56 which perform management of information ID or each protocol, control, etc. in the communication control function will be explained using FIGS. 9A-12.

FIGS. 9A-9D are flowcharts for explaining the communication control function concerning the embodiment 1 of the invention (when information ID is adapted to specify protocol information ID).

FIG. 9A is a flowchart for explaining DeviceOpen( ). FIG. 9B is a flowchart for explaining DeviceGet( ) . FIG. 9C is a flowchart for explaining DeviceClose( ). FIG. 9D is a flowchart for explaining the protocol-specific communication processing.

As shown in FIG. 9A, when called from the application program, DeviceOpen( ) determines whether the protocol specification parameter is specified as automatic (S1). DeviceOpen( ) sets the protocol specification flag to ON when the value of protocol specification is specified as automatic (S2).

Then, initializing processing is performed (S3) and control is returned to the application program. The application program specifies information ID of device information to acquire from the device side, and calls DeviceGet( ) of FIG. 9B.

DeviceGet( ) determines whether a protocol specification flag is ON (S11). When the protocol specification flag is ON, information ID retrieval processing is called based on the information ID (S12). The information ID retrieval processing determines whether the information ID is registered in protocol information ID definition file 55 of each protocol (S13). The result is returned to DeviceGet( ).

When the information ID exists (YES at S13), DeviceGet( ) calls the protocol-specific communication processing based on the detected protocol and information ID (S14). DeviceGet( ) creates a return value based on the communication result (acquired device information) from the protocol-specific communication processing, and returns it to the application program (S15).

On the other hand, when information ID does not exist at step S13, a return value which notifies that is created and it is returned to the application program (S15).

And the application program calls DeviceClose( ). DeviceClose( ) performs post-processing shown in FIG. 9C (S21), and returns the result to the application program.

It is detected whether the protocol-specific communication processing is registered in the protocol information ID definition file 55 based on information ID by the protocol-specific communication processing of FIG. 9D (S22).

When registered, the information (applicable access method) related to the information ID is acquired (S23). And communication processing is performed with the device according to the acquired information (S24). And a communication result (acquired device information) is returned to DeviceGet( ) (S25).

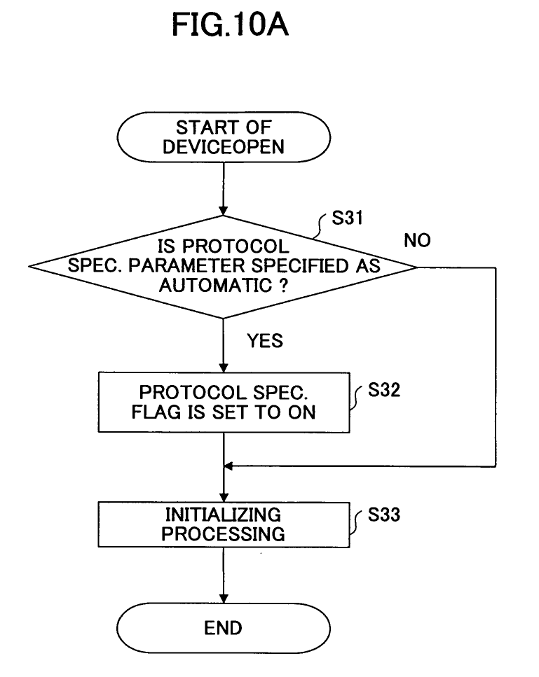

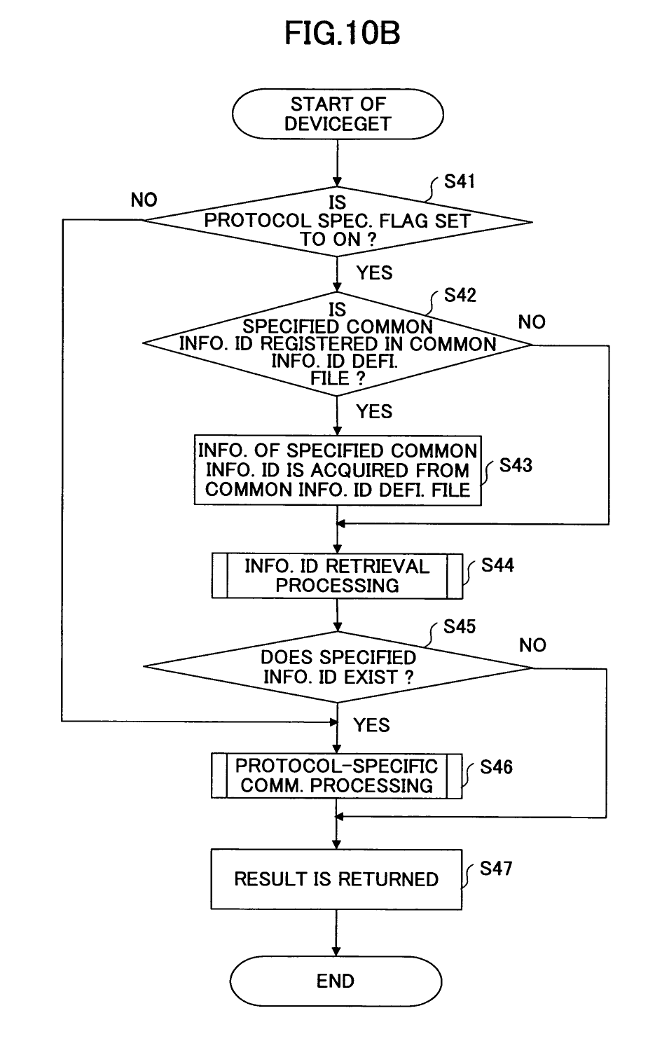

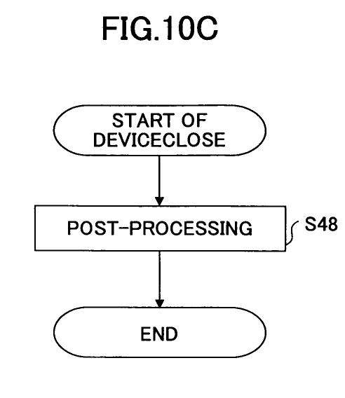

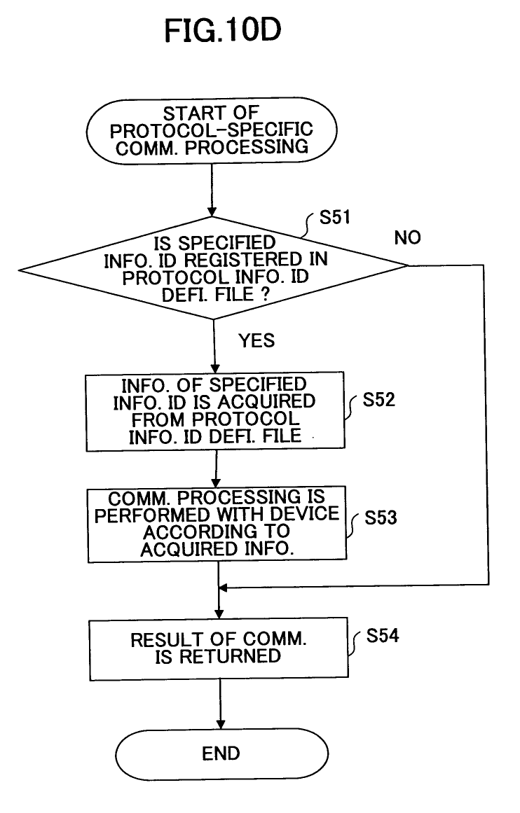

FIGS. 10A-10D are flowcharts for explaining the communication control function concerning the embodiment 1 of the invention (when information ID is adapted to specify both common information ID and protocol information ID).

FIG. 10A is a flowchart for explaining DeviceOpen( ). FIG. 10B is a flowchart for explaining DeviceGet( ) . FIG. 10C is a flowchart for explaining DeviceClose( ). FIG. 10D is a flowchart for explaining the protocol-specific communication processing.

As shown in FIG. 10A, when DeviceOpen( ) is called by application, it is determined whether the automatic is specified as the protocol specification parameter (S31).

DeviceOpen( ) sets a protocol specification flag as ON, when the value of protocol specification has an automatic specified (S32).

Then, initializing processing is performed (S33), and the control is returned to the application program. The application program calls DeviceGet( ) of FIG. 10B by specifying information ID of device information being acquired from the device side.

DeviceGet( ) determines whether the protocol specification flag is set to ON (S41). When the protocol specification flag is ON, DeviceGet( ) determines whether the specified information ID is registered in the common information ID definition file 52 (S42).

When registered, DeviceGet( ) acquires the information of the information ID (S43). DeviceGet( ) calls the information ID retrieval processing based on the information ID (S44).

It is detected through the information ID retrieval processing whether the information ID is registered in the protocol information ID definition file 55 of each protocol based on the information ID (S45).

The information ID retrieval processing returns a result of the detection to DeviceGet( ).

When the information ID exists, DeviceGet( ) calls the protocol-specific communication processing based on the protocol and the detected information ID (S46).

DeviceGet( ) creates a return value based on the communication result (acquired device information) from the protocol-specific communication processing, and returns it to the application program (S47).

On the other hand, when the information ID does not exist at step S45, DeviceGet( ) creates a return value which notifies such, and returns it to the application program (S47). And the application program calls DeviceClose( ).

DeviceClose( ) performs post-processing of FIG. 10C (S48), and returns the result to the application program.

It is detected through the protocol-specific communication processing whether the information ID is registered in the protocol information ID definition file 55 based on the information ID, as shown in FIG. 10D (S51).

When it is registered, the protocol-specific communication processing acquires the information (applicable access method) related to the information ID (S52).

The protocol-specific communication processing performs communication processing according to the information (S53), and returns a communication result (acquired device information) to DeviceGet( ) (S54).

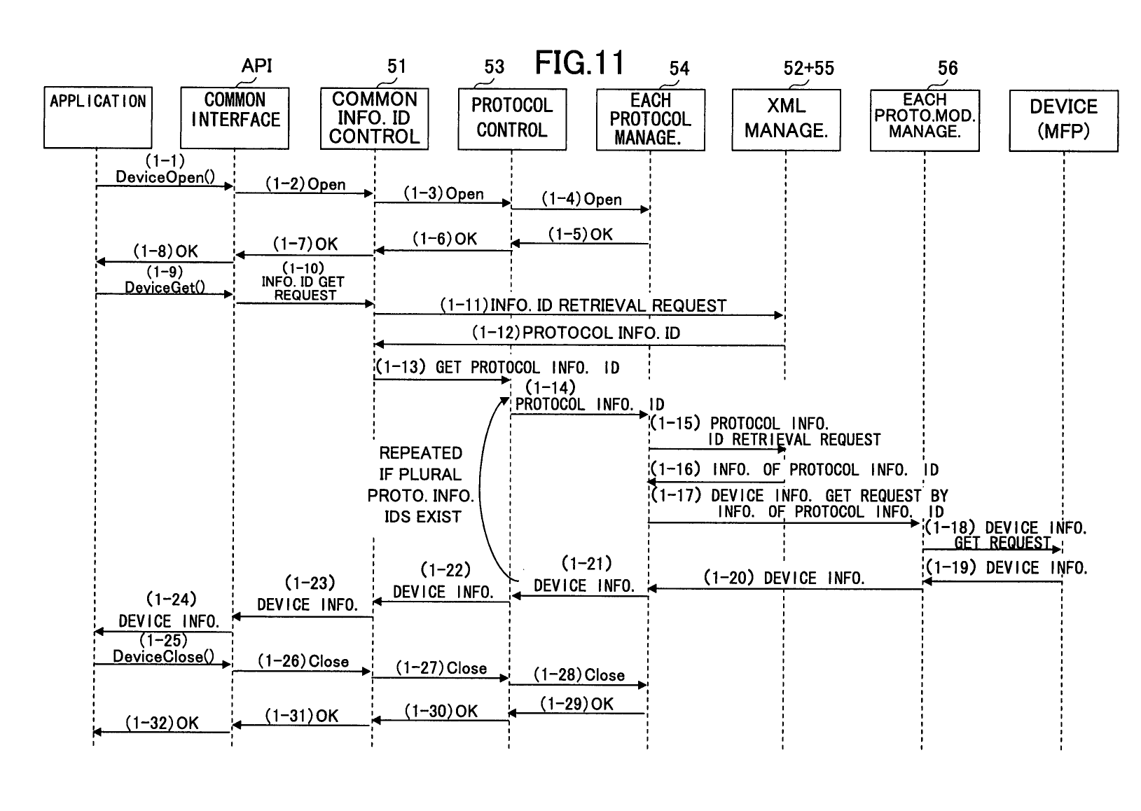

FIG. 11 shows an example of the procedure of the communication control function (when information ID can specify by protocol information ID) concerning the embodiment 1 of the invention.

As shown in FIG. 11, the common interface denotes the common interface (common API: communication control interface) layer API in the network-layer NL of FIG. 4. The common information ID control part 51 is a manager (management part) which controls the common ID management service in the service layer MS of FIG. 4.

The protocol control part 53 performs management of each protocol ID, control, and communication control (control of each protocol management part 54) of the protocol.

Each protocol management part 54 is a manager (management part) which performs control to each protocol in protocol layer PL of FIG. 4. The XML management includes the common information ID definition file 52 and the protocol information ID definition file 55.

Each protocol module management part 56 is a manager (management part) which performs protocol module control of SNMP, FTP, HTTP, SOAP, etc. in the protocol layer of FIG. 4.

The application program AP calls the Open function of common interface (1-1). By this, the common interface sends an Open request to the common information ID control part 51, the protocol control part 53, and each protocol management part 54 (1-2 to 1-4).

The common information ID control part 51 performs initialization processing within the common information ID control part 51.

When the protocol specification is specified as the automatic, the common information ID control part 51 sends an Open request to each protocol management part 54 through the protocol control part 53 (1-2 to 1-4). Each protocol management part 54 performs the initialization processing of each protocol and notifies to the common information ID control part 51 that processing of the Open request is finished (1-5 to 1-6).

The common information ID control part 51 notifies the common interface that the processing of the Open request is finished, when the common information ID control part 51 is notified from the protocol control part 53 (1-7). The common interface notifies, when it is notified from the common information ID control part 51, to the application program AP that the processing of the Open request is finished (1-8).

Next, in order to acquire device information, the application program AP requests to the common interface, by calling DeviceGet( ) with the argument (parameter) including the information ID related to the device information being acquired (1-9).

The information ID of each protocol is specified as the information ID related to the device information. The common interface sends an acquisition request to the common information ID control part 51 (1-10). The common information ID control part 51 requests to the XML management that the information ID related to the device information being acquired should be searched in the XML-form information ID definition files 52 and 55 based on the information ID (1-11).

The XML management determines whether the specified information ID exists by making reference to the protocol information ID definition file 55. When the specified information ID exists, the XML management notifies the protocol name and information ID indicated in the XML data to the common information ID control part 51 (1-12). In the case where a device name is requested as the device information being acquired by using the SNMP, “sysName” is notified to the common information ID control part 51.

The common information ID control part 51 notifies each protocol management part 54 through the protocol control part 53 of the protocol name and the information ID obtained from the XML management (1-13 to 1-14).

Each protocol management part 54 notifies the information ID of the specified protocol name to the XML management (1-15).

Based on the information ID of the specified protocol name, the XML management searches each protocol information ID definition file 55, acquires the access method of the information ID from the corresponding protocol information ID definition file 55, and notifies each protocol management part 54 of the access name (1-16). For example, the information notified at this time to each protocol management part 54 is, when a sheet-supply tray name is requested as the acquired device information, the Printer-MIB object name of “prtInputName” obtained from the XML file of the access method shown in FIG. 7.

Subsequently, each protocol management part 54 notifies each protocol module management part 56 of the protocol name and the access method of the information ID (1-17). Each protocol module management part 56 acquires device information from the device, with respect to the module of the specified protocol name, according to the notified access method (1-18 to 1-19), and notifies each protocol management part 54 of the acquired device information (1-20).

The procedure from 1-14 to 1-21 is repeated for the number of information IDs when a plurality of information IDs obtained from the XML management exist. For example, when device information being acquired using the SOAP is a device name, two sets of information ID exist: “system.systemame:1” and “device.name:1”. The procedure is repeated for the number of information IDs, the device information for all the information IDs is acquired.

Each protocol management part 54 collects all the device information of the information IDs, and notifies it to the common information ID control part 51 through the protocol control part 53 (1-21 to 1-22).

The common information ID control part 51 notifies the device information of all the information IDs to the common interface (1-23). The common interface notifies the device information of all the information IDs to the application program AP (1-24).

Thereby, the application program AP performs appropriate processing (information display etc.) based on the device information of all the acquired information IDs.

And the application program sends a Close request to the common interface (1-25).

Therefore, the common interface performs the post-processing within the common interface, and sends a “Close” request to the common information ID control part 51 (1-26). The common information ID control part 51 performs the post-processing within the common information ID control part 51, and sends a “Close” request to each protocol management part 54 through the protocol control part 53 (1-27 to 1-28).

Each protocol management part 54 performs the post-processing within each protocol management part 54, and reports to the common information ID control part 51 through the protocol control part 53 that the post-processing is finished (1-29 to 1-30).

The common information ID control part 51 notifies the common interface that the post-processing is finished (1-31). The common interface reports to the application program AP that the post-processing is finished (1-32), so that the processing of the series of communication control functions is finished.

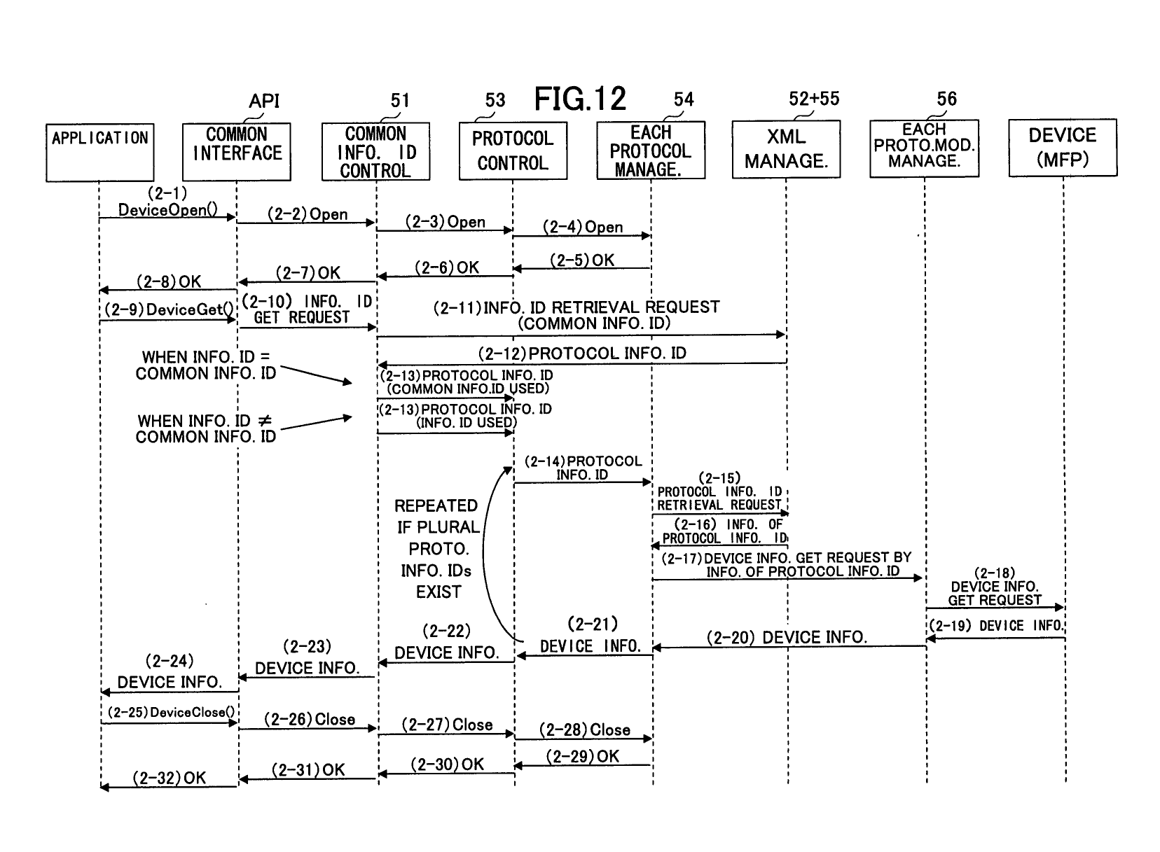

FIG. 12 shows an example of the procedure of the communication control function (when information ID can specify both common information ID and protocol information ID) concerning the embodiment 1 of the invention.

As shown in FIG. 12, the application program AP calls the Open function of common interface (2-1). By this, the common interface sends an Open request to the common information ID control part 51, the protocol control part 53, and each protocol management part 54 (2-2 to 2-4).

The common information ID control part 51 performs initialization processing within the common information ID control part 51. When the protocol specification is specified as the automatic, the common information ID control part 51 sends an Open request to each protocol management part 54 through the protocol control part 53 (2-2 to 2-4). Each protocol management part 54 performs initialization processing of each protocol, and notifies to the common information ID control part 51 that processing of the Open request is finished (2-5 to 2-6).

The common information ID control part 51 notifies the common interface that processing of the Open request is finished, when the common information ID control part 51 is notified from the protocol control part 53 (2-7). The common interface notifies, when it is notified from the common information ID control part 51, to the application program AP that processing of the Open request is finished (2-8).

Next, in order to acquire device information, the application program AP requests the common interface, by calling DeviceGet( ) with the argument (parameter) including the information ID related to the device information being acquired (2-9). It is possible to specify not only the information ID of each protocol but also the common information ID as ID related to the device information.

For example, what is necessary is just to specify “Get SystemName”, when acquiring the device name shown in FIG. 8.

The common interface requests the common information ID control part 51 to acquire the information ID related to the device information (2-10). The common information ID control part 51 requests the XML management that the information ID should be searched in the XML-form information ID definition files 52 and 55 based on the information ID (2-11).

The XML management determines whether the specified information ID exists, by making reference to the common information ID definition file 52 and each protocol information ID definition file 55. When it exists and the requested information ID is a common information ID, the XML management notifies the protocol name, indicated in the XML data, and the information ID to the common information ID control part 51 (1-12).

In the case of the example of FIG. 8, (a) SNMP protocol and ID=sysName, (b) SOAP protocol and ID=system.systemame:1, or (c) SOAP protocol and ID=device.name:1 is notified.

When the requested information ID is information ID of the protocol, a protocol name and its information ID are notified to the common information ID control part 51.

The common information ID control part 51 notifies each protocol management part 54 through the protocol control part 53 of the protocol name obtained from the XML management, and its information ID (2-13 to 2-14).

Each protocol management part 54 notifies the information ID of the specified protocol name to the XML management (2-15).

Based on the information ID of the specified protocol name, the XML management searches each protocol information ID definition file 55, acquires the access method of the information ID from the corresponding protocol information ID definition file 55, and notifies it to each protocol management part 54 (2-16).

At this time, the information which is notified to each protocol management part 54 is, for example, the Printer-MIB object name of “prtInputName” from the XML file of the access method shown in FIG. 7, if a sheet-supply tray name is requested in the acquired device information.

Subsequently, each protocol management part 54 notifies each protocol module management part 56 of the access method of the protocol name and its information ID (2-17).

Each protocol module management part 56 acquires device information from the device with respect to the module of the specified protocol name according to the obtained access method (2-18 to 2-19), and notifies each protocol management part 54 of the acquired device information (2-20).

The procedure from 2-14 to 2-21 is repeated for the number of information IDs the device information, when the plurality of the protocol names and information IDs of those obtained from the XML management exist.

Each protocol management part 54 collects the device information for all the information IDs, and notifies it to the common information ID control part 51 through the protocol control part 53 (2-21 to 2-22). The common information ID control part 51 notifies the device information of all the information IDs to the common interface (2-23). The common interface notifies the device information of all the information IDs to the application program AP (2-24).

Thereby, the application program AP performs appropriate processing (information display etc.) based on the device information of all the acquired information IDs, and sends a “Close” request to the common interface (2-25).

Therefore, the common interface performs the post-processing within the common interface, and sends a “Close” request to the common information ID control part 51 (2-26). The common information ID control part 51 performs the post-processing within the common information ID control part 51, and sends a “Close” request to each protocol management part 54 through the protocol control part 53 (2-27 to 2-28).

Each protocol management part 54 performs the post-processing in each protocol management part 54, and reports to the common information ID control part 51 through the protocol control part 53 that the post-processing is finished (2-29 to 2-30).

The common information ID control part 51 notifies the common interface that the post-processing is finished (2-31). The common interface reports to the application program AP that the post-processing is finished (2-32). The series of the processing of the communication control function is thus finished.

As described above, according to the embodiment 1 of the invention, while it is not necessary for the application program AP to be conscious of the difference of the protocol in the parameter when acquiring device information, it is possible to carry out communication with a device only by specifying common information ID or protocol information ID, and the burdens of the application program AP can be eased.

When performing communication with a device, it is not necessary to perform complicated processing before communicating with the device, and the processing time needed before connection can be shortened through downloading of the module for connection from an external device connected via the network.

### Embodiment 2

When acquiring device information using an XML form message, the descriptive content can be defined, but since the contents of XML data are maker dependence or are model dependence, the similarity is not necessarily guaranteed.

Therefore, when an acquisition request is carried out to the same device information among device information acquirable by two or more protocols, the values of the device information acquired from each protocol may differ.

In this embodiment, in order to solve the above-mentioned problem, when the values of the device information acquired from each protocol among device information acquirable by two or more protocols differ, the communication control function for unifying them and enabling it to treat will be explained.

The point that this embodiment differs from Embodiment 1 is a point that the data-type conversion function (data-type conversion service) changed into the data type which unified the value of the acquired device information based on the communication control function of Embodiment 1 is added.

Therefore, explanation is omitted using the same sign and the system configuration of FIG. 1 which is a common appearance with this embodiment used by explanation of Embodiment 1, and the example of the hardware configuration of FIG. 2A and FIG. 2B are explained focusing on the contents related to a different data-type conversion function from the embodiment 1.

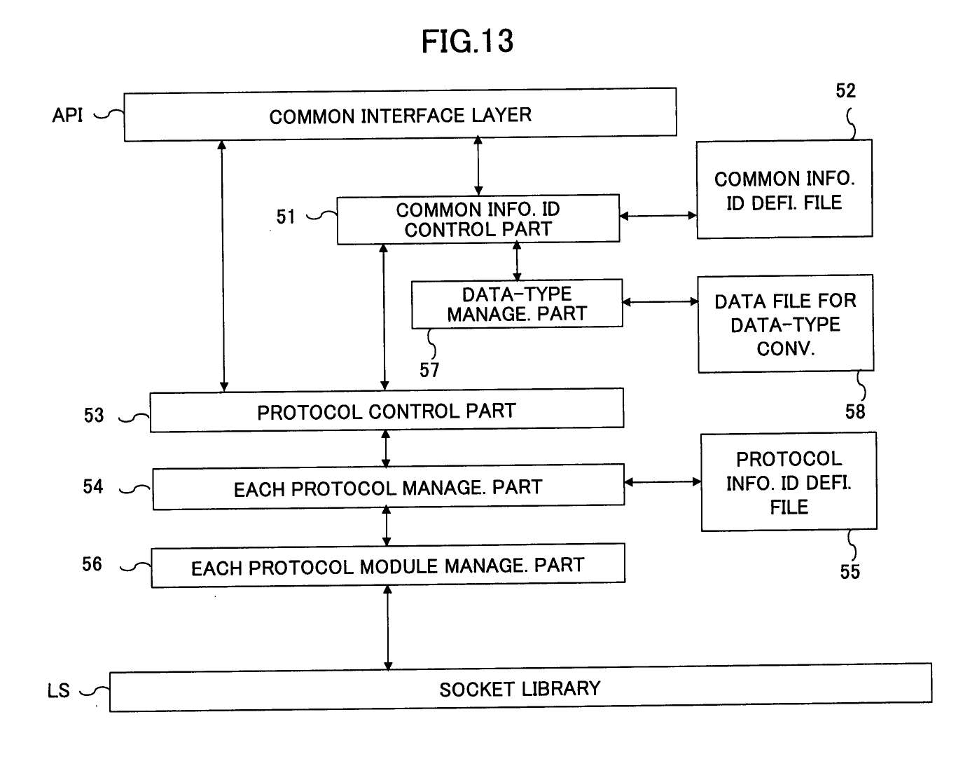

FIG. 13 shows the functional composition of the communication control function concerning the embodiment 2 of the invention.

This communication control function includes, in addition to the common information ID control part 51, the common information ID definition file 52, the protocol control part 53 each protocol management part 54, the protocol information ID definition file 55 and each protocol module management part 56, a data data-type management part 57 which converts into the unified data type the value of the acquired device information to manage the data type, and a data file 58 for data-type conversion holding the data for data-type conversion. The communication control function of this embodiment is aimed at performing communication control, without making the application program conscious of the difference of the data type in a protocol.

The data file 57 for data-type conversion used when converting the data type according to the communication control function will be explained.

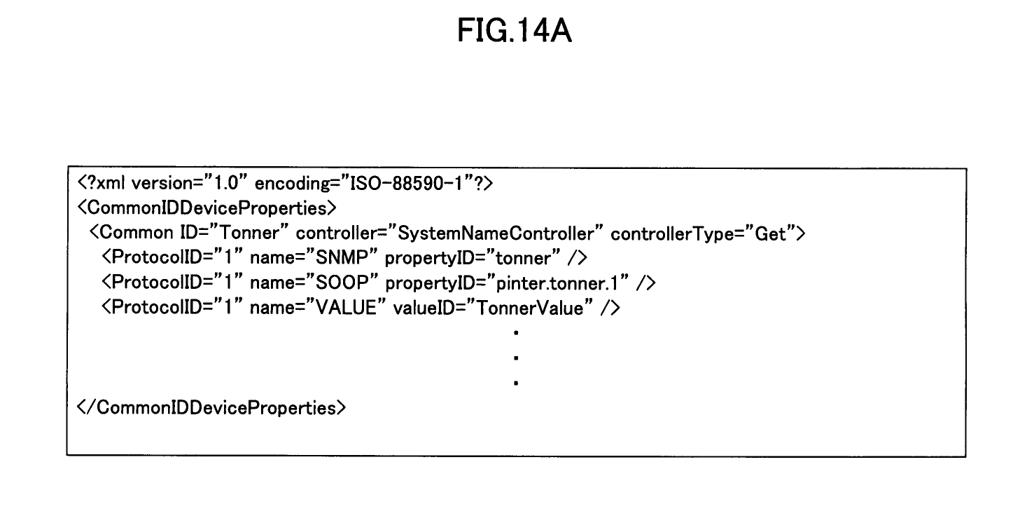

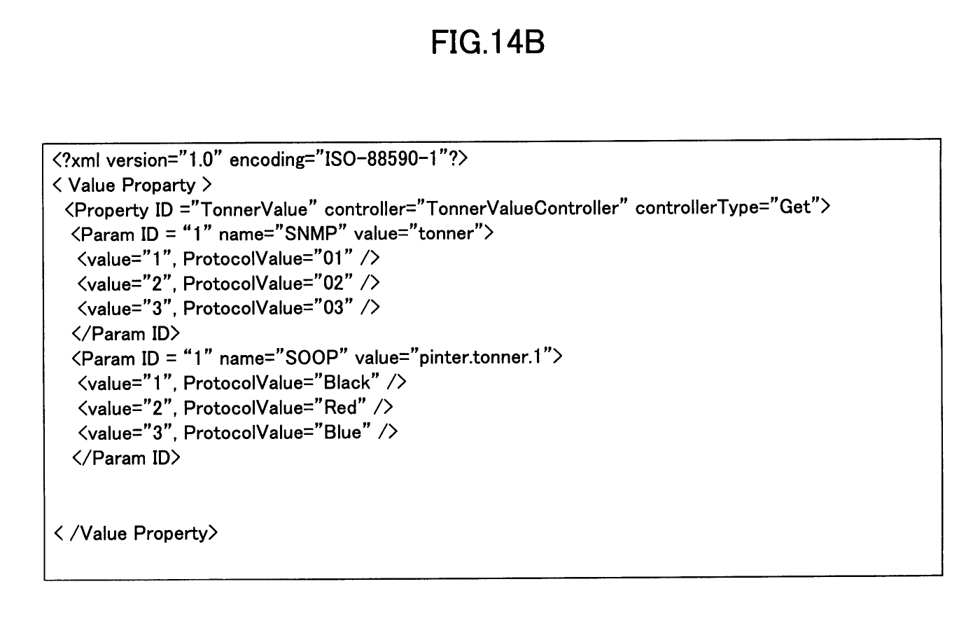

FIG. 14A shows an example of the common information ID definition file (XML file) related to toner. FIG. 14B shows an example of the XML file which collects a different value.

When the values of the device information acquired from each protocol among device information acquired from a plurality of protocols are different, the data file 58 for data-type conversion is used for unifying them and enabling the processing of them.

For example, consider the case in which whether it can acquire by each protocol of SNMP and SOAP, and acquires by SNMP in order to acquire the color of the toner of a device, or it acquires by SOAP consider the case of being dependent on the protocol which the device side is supporting. When there is no unified condition, such as “the color of a toner acquired by using the SNMP should be returned as a numerical value” or “the color of a toner acquired by using the SOAP should be returned as a character string”.

When the value to which the device side returns device information is not unified so that it may say that it returns by a character string”, in the processing which acquires the device information of application, processing in which a number is changed into a character string (a data type is changed) will be performed, and a burden is placed.

In this embodiment, toner information is acquired using ID of “Toner” shown in FIG. 14A. It is defined by the common information ID definition file of FIG. 14A that “Toner” is acquirable by using one of SNMP and the SOAP. “VALUE” is an identifier for making it the value which unified the value of SNMP or SOAP. “ValueID” is “TonerValue”. “TonerValue” is referred to when referring to the data file for data-type conversion of FIG. 14B.

When it acquires by SNMP, the column of name=“SNMP” and value=“tonner” is detected. When it acquires by SOAP, the column of name=“SOAP” and value=“printer.tonner.1” is detected.

When the value of “tonner” is acquired by “02” in the case of SNMP, “2” of value=“2” is returned to the application program as a value of “Toner” as follows.

When the value of “printer.tonner.1” is acquired by “Red” in SOAP, “2” of value=“2” is returned to the application program as a value of “Toner” as follows.

Even if the value of the acquired device information is a number and it is a character, it is converted into the unified data type and can return to the application program.

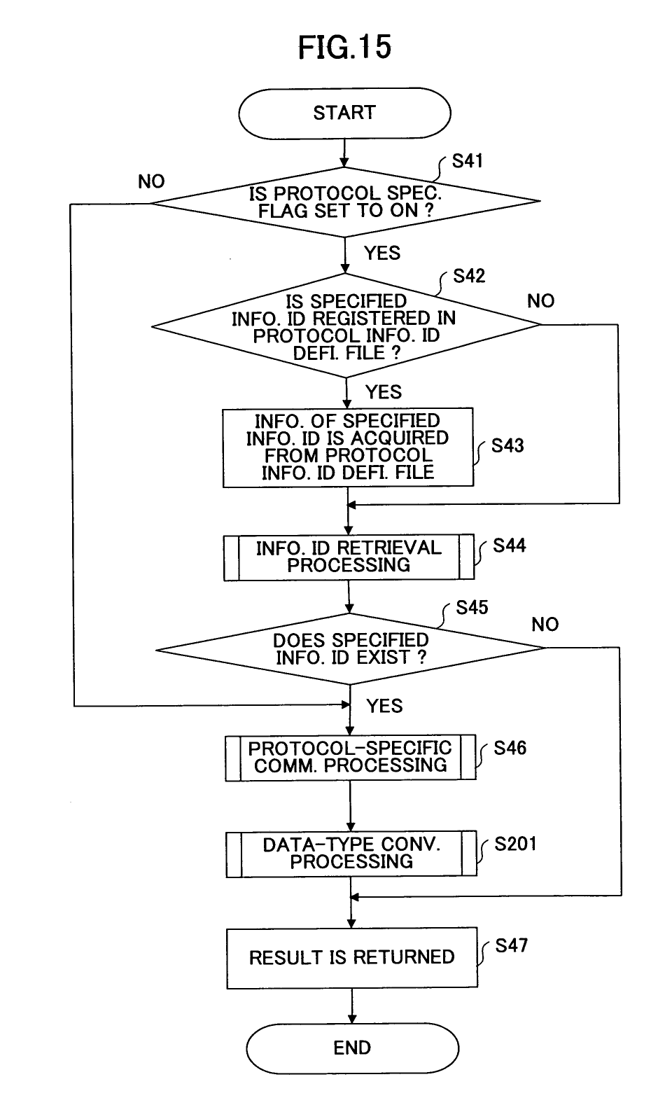

Next, it is converted into the data type which unified the value of the acquired device information mentioned above in the communication control function, and data-type management part 58 which manages a data type will be explained with reference to FIGS. 15-17.

FIG. 15 is a flowchart for explaining DeviceGet( ) in the communication control function concerning the embodiment 2 of the invention.

In the following, DeviceOpen( ), DeviceClose( ), and the protocol-specific communication processing are explained using FIG. 10A-FIG. 10D.

As shown in FIG. 10A, when DeviceOpen( ) is called from the application program, it determines whether the automatic is specified as the protocol specification parameter (S31).

DeviceOpen( ) sets a protocol specification flag as ON, when the value of protocol specification has an automatic specified (S32).

Then, DeviceOpen( ) performs initializing processing (S33) and returns it to the application program.

The application program specifies information ID of device information being acquired from the device side, and calls DeviceGet( ) of FIG. 15.

DeviceGet( ) determines whether the protocol specification flag is set to ON (S41). When the protocol specification flag is ON at S41, it detects whether the specified information ID is registered in the common information ID definition file 52 (S42). When it is registered at S42, the information of the information ID is acquired (S43).

The information ID retrieval processing is called based on the information ID (S44), and it is detected through the information ID retrieval processing whether the information ID is registered in the protocol information ID definition file 55 of each protocol based on the information ID (S45). The result is returned to DeviceGet( ).

When the information ID exists at S45, DeviceGet( ) calls the protocol-specific communication processing based on the detected protocol and the information ID (S46).

The data-type conversion processing is called based on the value acquired from the communication result (S201), and DeviceGet( ) creates a return value based on a communication result (acquired device information) and a conversion result (unified data type), and the control is returned to the application program (S47).

On the other hand, when the information ID does not exist at step S45, the return value which notifies such is created, and it is returned to the application program (S202).

And the application program calls DeviceClose( ). DeviceClose( ) performs post-processing of FIG. 10C (S48), and returns the result to the application program.

It is determined whether the protocol-specific communication processing is registered into protocol information ID definition file 55 based on information ID, as shown in FIG. 10D (S51).

When registered, the protocol-specific communication processing acquires the information (applicable access method) related to the information ID (S52), performs communication processing according to the information (S53), and returns a communication result (acquired device information) to DeviceGet( ) (S54).

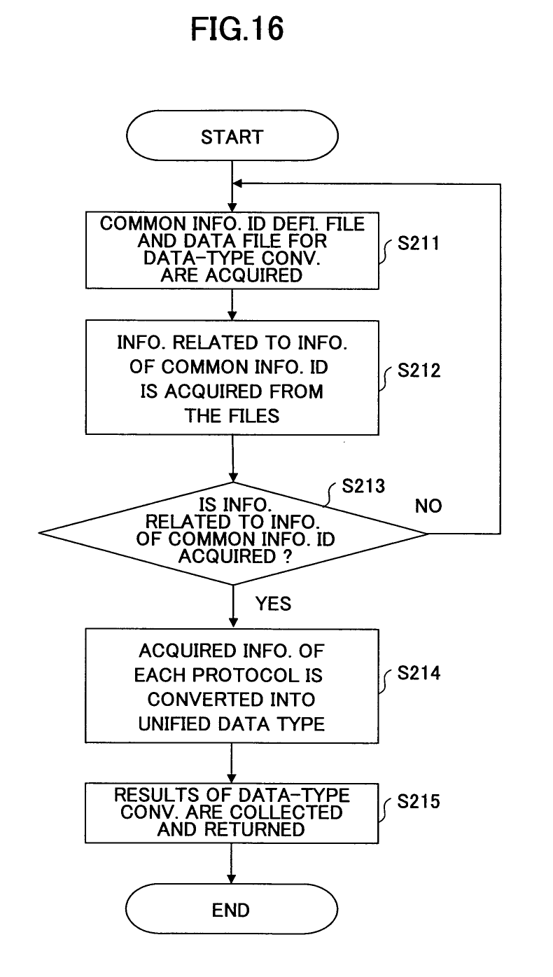

FIG. 16 is a flowchart for explaining the data-type conversion processing in the communication control function concerning the embodiment 2 of the invention.

The data-type conversion processing acquires the common information ID definition file 52 and the data file 58 for data-type conversion (S211).

Based on the information of common information ID, the information relevant to common information ID is acquired from common information ID definition file 52 and data file 58 for data-type conversion (S212).

And it is detected based on the information of specified common information ID, whether the information relevant to the common information ID is acquired (S213).

When it is acquired at S213, based on the communication result, the protocol-specific communication processing converts the information relevant to the common information ID into the unified value of the information acquired from each protocol (S214), and returns a conversion result (unified data type) to DeviceGet( ) (S215).

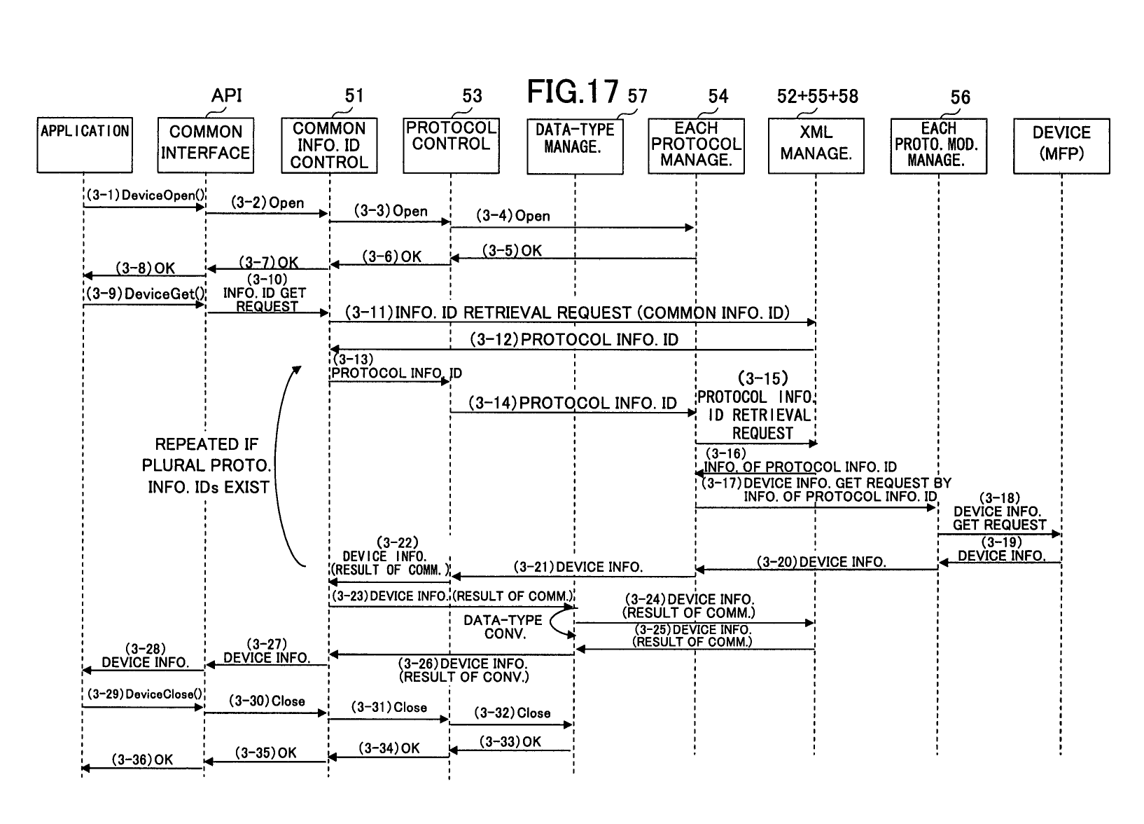

FIG. 17 shows an example of the procedure of the communication control function concerning the embodiment 2 of the invention.

As shown in FIG. 17, the application program AP calls the Open function of the common interface (3-1). The common interface sends an Open request to the common information ID control part 51, the protocol control part 53, and each protocol management part 54 (3-2 to 3-4).

The common information ID control part 51 performs initialization processing within the common information ID control part 51. When the protocol specification is specified as the automatic, the common information ID control part 51 sends an Open request to each protocol management part 54 through the protocol control part 53 (3-2 to 3-4). Each protocol management part 54 performs initialization processing of each protocol, and notifies to the common information ID control part 51 that processing of the Open request is finished (3-5 to 3-6).

The common information ID control part 51 notifies the common interface that processing of the Open request is finished, when the common information ID control part 51 is notified from the protocol control part 53 (3-7). The common interface notifies, when it is notified from the common information ID control part 51, to the application program AP that processing of the Open request is finished (3-8).

Next, in order to acquire device information, the application program AP requests the common interface by calling DeviceGet( ) with the argument (parameter) including the information ID related to the device information being acquired (3-9). It is possible to specify not only the information ID of each protocol but the common information ID as the information ID related to the device information. For example, what is necessary is just to specify “Get SystemName”, when acquiring the device name shown in FIG. 8.

The common interface requests to the common information ID control part 51 the information ID related to the device information being acquired (3-10). The common information ID control part 51 requests to the XML management that the information ID should be searched in the XML-form information ID definition files 52 and 55 based on the information ID (3-11).

The XML management determine whether the specified information ID exists by making reference to the common information ID definition file 52 and each protocol information ID definition file 55. When the specified information ID is common information ID and the specified information ID exists, the protocol name indicated in the XML data and its information ID are notified to the common information ID control part 51 (3-12).

In the case of the example of FIG. 8, (a) SNMP protocol and ID=sysName, (b) SOAP protocol and ID=system.systemame:1, or (c) SOAP protocol and ID=device.name:1 is notified.

When the specified information ID is information ID of a protocol, the protocol name and its information ID are notified to the common information ID control part 51.

The common information ID control part 51 notifies each protocol management part 54 of the protocol name obtained from the XML management, and its information ID through the protocol control part 53 (3-13 to 3-14).

Each protocol management part 54 notifies the specified protocol name and the information ID to the XML management (3-15).

Based on the information ID of the specified protocol name, the XML management searches each protocol information ID definition file 55, acquires the access method of the information ID from the corresponding protocol information ID definition file 55, and notifies each protocol control part 54 of it (3-16).

For example, the information which is notified to each protocol management part 54 at this time is the Printer-MIB object name of “prtInputName” from the XML file of the access method shown in FIG. 7, if a sheet-supply tray name is required of the acquired device information.

Subsequently, each protocol management part 54 notifies each protocol module management part 56 of the access method of the protocol name and its information ID (3-17).

Each protocol module management part 56 acquires the device information from the device with respect to the module of the specified protocol name according to the obtained access method (3-18 to 3-19), and notifies each protocol management part 54 of the acquired device information (3-20).

The procedure from 3-14 to 3-21 is repeated to acquire the device information for all the information IDs when the plurality of the protocol names obtained from the XML management and the plurality of information IDs of those exist.

Each protocol management part 54 collects the device information of all the information IDs, and notifies them to the common information ID control part 51 through the protocol control part 53 (3-21 to 3-22). The common information ID control part 51 converts, when the information ID is common information ID, into the unified value the value of the information ID of each protocol indicated in the common information ID definition file 52, and collection of the results of the conversion is requested to the data-type management part 57 (3-23).

The data-type management part 57 notifies to the XML management the acquisition request of the common information ID definition file 52 and the data file 57 (refer to FIG. 14B) for data-type conversion (3-24).

The XML management uses the common information ID as a key, and the information relevant to the common information ID is acquired from the information of the common information ID, and the data file 58 for data-type conversion. The XML management notifies the acquired information to the data-type management part 57 (3-25). The data-type management part 57 converts the information acquired from the XML management into the unified value of the information ID of each protocol collected and notifies the value after conversion to the common information ID control part 51 (3-26).

The common information ID control part 51 notifies the device information of all the information IDs to the common interface (3-27), and the common interface notifies the device information of all the information IDs to the application program AP (3-28).

Thereby, the application program AP performs appropriate processing (information display etc.) based on the device information of all the acquired information IDs. And the application program sends a Close request to the common interface (3-29). And the common interface performs the post-processing within the common interface, and sends a Close request to the common information ID control part 51 (3-30). And the common information ID control part 51 performs the post-processing within the common information ID control part 51, and sends a Close request to each protocol management part 54 through the protocol control part 53 (3-31 to 3-32).

Each protocol management part 54 performs the post-processing in each protocol management part 54, and reports to the common information ID control part 51 through the protocol control part 53 that the post-processing is finished (3-33 to 3-34).

The common information ID control part 51 notifies the common interface that the post-processing is finished (3-35). The common interface reports to the application program AP that the post-processing is finished (3-36). The series of the processing of the communication control function is thus finished.

As described above, according to the embodiment 2 of the invention, while it is not necessary for the application program AP to be conscious of the difference of the protocol in the parameter when acquiring device information, it is possible to carry out communication with a device only by specifying common information ID, and the burdens of the application program AP can be eased.

When performing communication with a device, it is not necessary to perform complicated processing before communicating with the device, and the processing time needed before connection can be shortened through downloading of the module for connection from an external device connected via the network.

### Embodiment 3

When the data acquired from each protocol is a character string, the XML data file when acquiring device information using SOAP is UTF-8 code, and the character code (it is Shift JIS in the case of Japanese) for every language is used in the case of SNMP, the character encoding scheme processed by the protocol for acquiring device information is also protocol dependence. It is not necessary for the application program to be conscious of the difference in a character code as the corresponding protocol increases.

In this embodiment, the above-mentioned problem is eliminated, and when the device information acquired by using two or more protocols and the value of the device information acquired from each protocol is a character string, the communication control function is adapted for converting those character codes into the character code specified by the application program in order to enable the processing of them.

The point that this embodiment differs from Embodiment 1 is a point that the character code conversion function (character code conversion service) changed into the character code which had the character string of the acquired device information specified based on the communication control function of Embodiment 1 is added.

Therefore, explanation is omitted using the same sign and the system configuration of FIG. 1 which is a common appearance with this embodiment used by explanation of the embodiment 1, and the example of the hardware configuration of FIG. 2A and FIG. 2B are explained focusing on the contents related to a different character code conversion function from the embodiment 1.

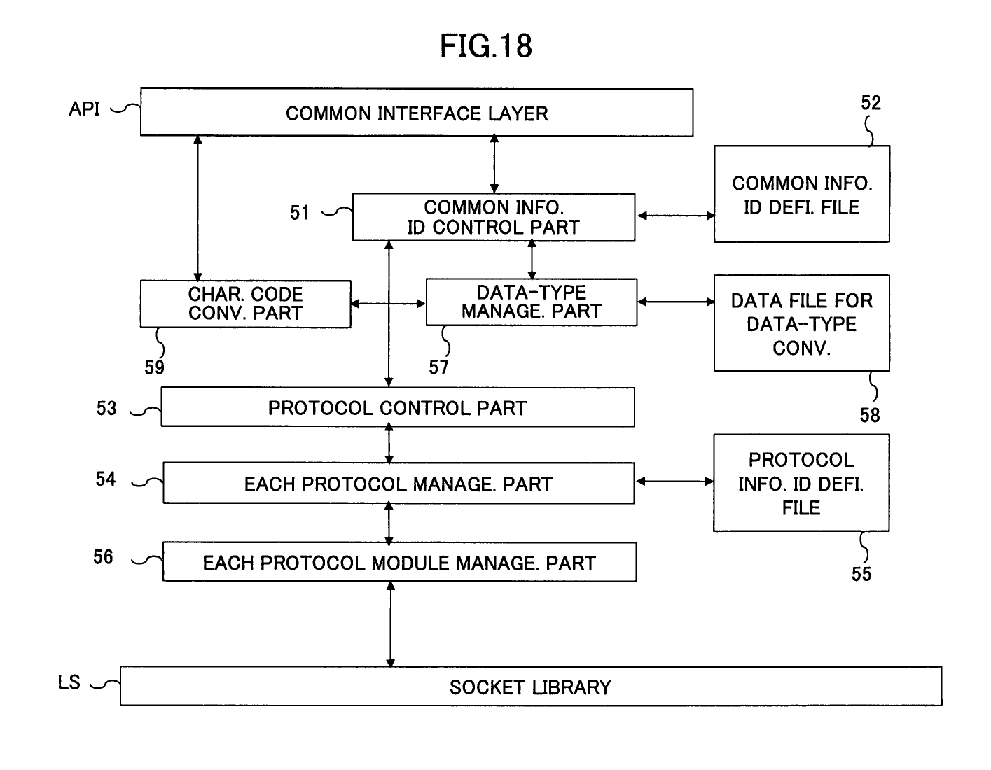

FIG. 18 shows the functional composition of the communication control function concerning the embodiment 3 of the invention.

This communication control function includes, in addition to the common information ID control part 51, the common information ID definition file 52, the protocol control part 53, each protocol management part 54, the protocol information ID definition file 55, each protocol module management part 56, the data-type management part 57 and the data file 58 for data-type conversion, a character code conversion part 59 which coverts the character string of the acquired device information into the specified character code. The communication control function of this embodiment is aimed at performing communication control, without making application conscious of the difference in the character code in a protocol.

Next, the character code conversion part 59 in the communication control function will be explained using FIGS. 18-22.

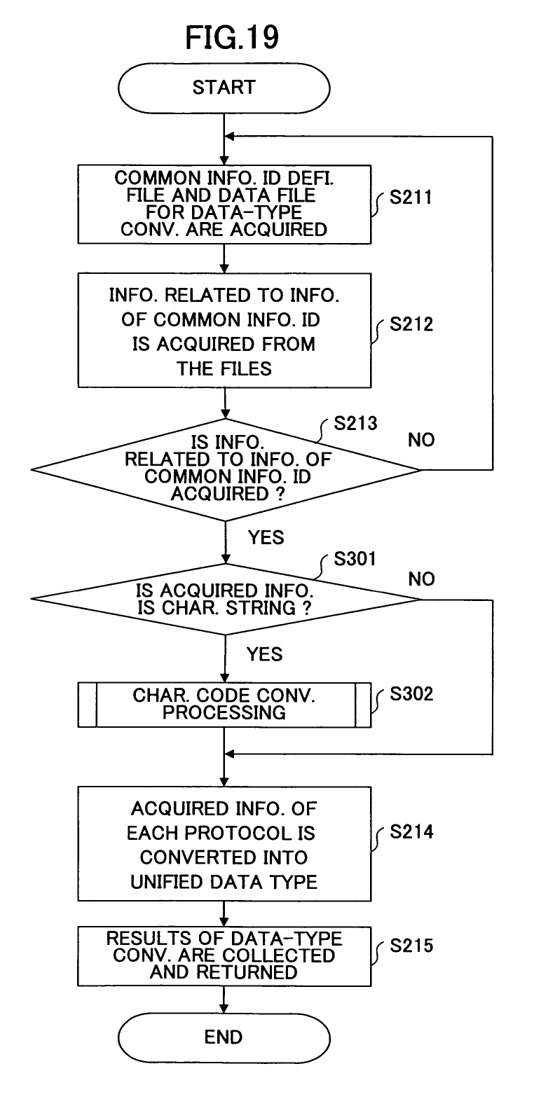

FIG. 19 is a flowchart for explaining the data-type conversion processing in the communication control function concerning the embodiment 3 of the invention.

In the following, DeviceOpen( ), DeviceGet( ), DeviceClose( ), and the protocol-specific communication processing are essentially the same as the procedures explained with FIGS. 10A-10D and FIG. 15, and a description thereof will be omitted.

As shown in FIG. 19, the data-type conversion processing acquires, when it is called from DeviceGet( ) of FIG. 15, the common information ID definition file 52 and the data file 58 for data-type conversion are acquired (S211). And the information relevant to common information ID is acquired from the common information ID definition file 52 and the data file 58 for data-type conversion based on the information of common information ID (S212).

And it is detected, based on the information of the specified common information ID, whether the information relevant to the common information ID is acquired (S213).

When it is acquired at S213, it is determined whether the acquired information is a character string (S301).

When it is a character string at S301, the character code conversion processing is called (S302).

Then, based on the communication result of the protocol-specific communication processing and the information relevant to the common information ID, the information acquired from each protocol is converted into the unified value (S214). And a conversion result (unified data type) is returned to DeviceGet( ) (S215).

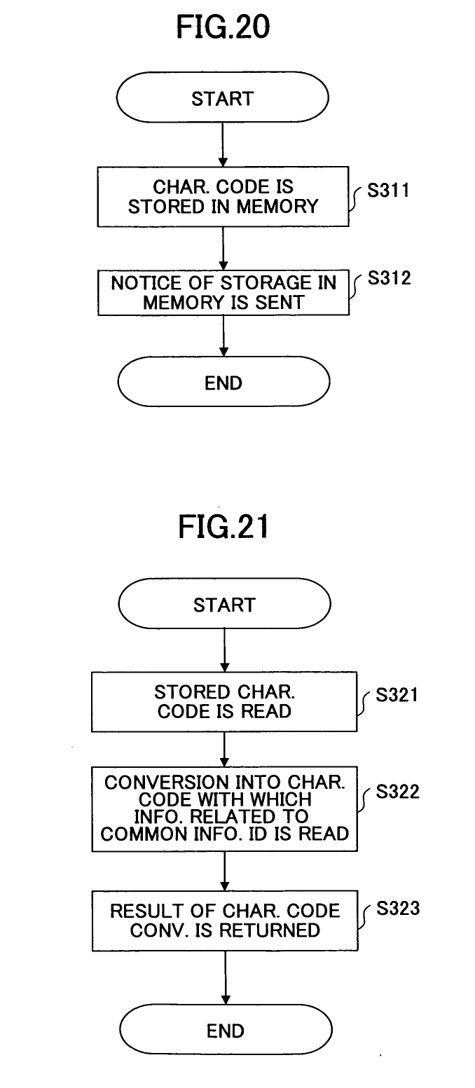

FIG. 20 is a flowchart for explaining SetCharCode( ) in the communication control function concerning the embodiment 3 of the invention.

SetCharCode( ) is a function which specifies the character code of the device information being acquired by the application program.

As shown in FIG. 20, SetCharCode( ) specifies, when it is called from the application program, the character code of the device information specified by the application program (the device information being converted), and temporarily stores it into the memory (the RAM 23) (S311). And SetCharCode( ) reports that the character code is stored temporarily (S312).

FIG. 21 is a flowchart for explaining the character code conversion processing in the communication control function concerning the embodiment 3 of the invention.

As shown in FIG. 21, the character code conversion processing reads, when it is called from the data-type conversion processing, the character code which is stored temporarily in the memory (the RAM 23) (S321), and converts the character string of the information relevant to the acquired common information ID into the read character code (S322). A character code conversion result is returned to the data-type conversion processing as a return value (S323).

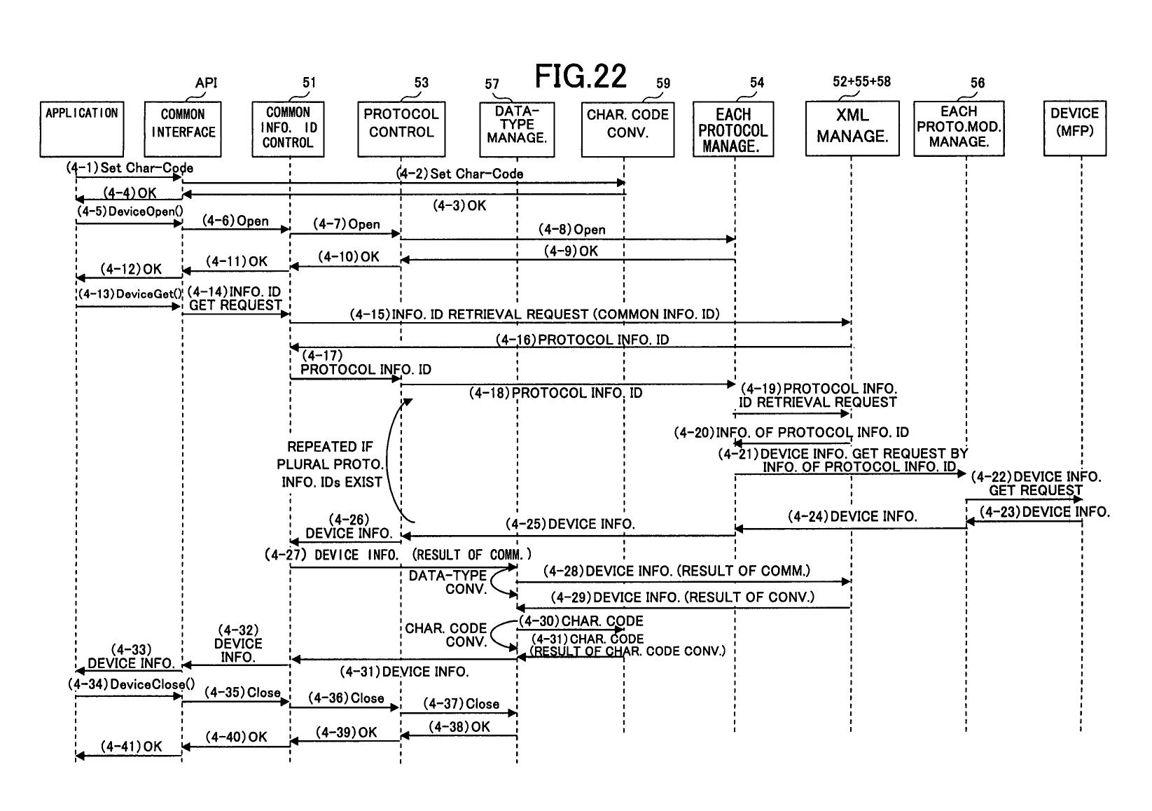

FIG. 22 shows an example of the procedure of the communication control function concerning the embodiment 3 of the invention.

As shown in FIG. 22, the application program AP notifies the character code being used to the common interface beforehand (4-1).

The common interface notifies the character code to the character code conversion part 59 (4-2). The character code conversion part 59 stores the character code temporarily into the memory (the RAM 23), and notifies to the common interface that it is stored (4-3). And the common interface reports to the application program AP that the character code is stored (4-4).

Next, the application program AP calls the Open function of the common interface (4-5). The common interface sends an Open request to the common information ID control part 51, the protocol control part 53, and each protocol management part 54 (4-6 to 4-8).

The common information ID control part 51 performs initialization processing within the common information ID control part 51. When the protocol specification is specified as the automatic, the common information ID control part 51 sends an Open request to each protocol management part 54 through the protocol control part 53 (4-6 to 4-8).

Each protocol management part 54 performs initialization processing of each protocol, and notifies to the common information ID control part 51 that processing of the Open request is finished (4-9 to 4-10).

The common information ID control part 51 notifies to the common interface that processing of the Open request is finished, when the common information ID control part 51 is notified from the protocol control part 53 (4-11). The common interface notifies, when it is notified from the common information ID control part 51, to the application program AP that processing of the Open request is finished (4-12).

Next, in order to acquire device information, the application program AP requests to the common interface the information ID related to the device information being acquired by calling DeviceGet( ) with the argument (parameter) including the information ID (4-13). It is possible to specify not only the information ID of each protocol but also the common information ID such as information ID related to the device information. For example, what is necessary is just to specify “Get SystemName” when acquiring the device name shown in FIG. 8.

The common interface requests to the common information ID control part 51 the information ID related to the device information being acquired (4-14). The common information ID control part 51 requests the XML management that the information ID should be searched in the XML-form information ID definition files 52 and 55 based on the information ID (4-15).

The XML management makes reference to the XML-form common information ID definition file 52 and each protocol information ID definition file 55, and detects whether the specified information ID exists in the files. When it exists and the specified information ID is a common information ID, the protocol name and information ID indicated in the XML data are notified to the common information ID control part 51 (4-16).

In the case of the example of FIG. 8, it notifies: (a) SNMP protocol and ID=sysName; (b) SOAP protocol and ID=system.systemame:1; or (c) SOAP protocol and ID=device.name:1.

When the specified information ID is a protocol information ID, a protocol name and its information ID are notified to the common information ID control part 51.

The common information ID control part 51 notifies each protocol management part 54 of the protocol name and its information ID obtained from the XML management through the protocol control part 53 (4-17 to 4-18).

Each protocol management part 54 notifies the information ID of the specified protocol name to the XML management (4-19). Based on the information ID of the specified protocol name, the XML management searches each protocol information ID definition file 55, acquires the access method of the information ID from the corresponding protocol information ID definition file 55, and notifies each protocol management part 54 of it (4-20).

At this time, the information which is notified to each protocol management part 54 is, for example, the Printer-MIB object name of “prtInputName” from the XML file of the access method shown in FIG. 7, if a sheet-supply tray name is requested by the acquired device information.

Subsequently, each protocol management part 54 notifies each protocol module management part 56 of the access method of the protocol name and its information ID (4-21).

Each protocol module management part 56 acquires device information from a device, with respect to the module of the specified protocol name, according to the obtained access method (4-22 to 4-23), and notifies each protocol management part 54 of the acquired device information (4-24).

If a plurality of protocol names and their information IDs obtained from the XML management exist, the procedure from 4-18 to 4-25 is repeated for the corresponding number so that it acquires the device information for all the information IDs.

Each protocol management part 54 collects the device information of all the information IDs, and notifies it to the common information ID control part 51 through the protocol control part 53 is requested to (4-24 to 4-26).

When the information ID is a common information ID, the common information ID control part 51 requests the data-type management part 57 that the value of the information ID of each protocol indicated in the common information ID definition file 52 is converted into the unified value, and they are collected (4-27).

The data-type management part 57 sends an acquisition request of the common information ID definition file 52 and the data file 57 (refer to FIG. 14B) for data-type conversion to the XML management (4-28).

The XML management uses the common information ID as a key, acquires the information of the common information ID and the information relevant to the common information ID from the data file 58 for data-type conversion, and notifies the acquired information to the data-type management part 57 (4-29).

The data-type management part 57 uses the information acquired from the XML management, converts the value of information ID of each protocol into the unified value, and collects the values after the conversion. Moreover, when the value of the common information ID from the common information ID control part 51 or the value after the data-type conversion is a character string, the data-type management part 57 notifies the character string to the character code conversion part 59 (4-30).

The character code conversion part 59 converts the character string into the character code stored temporarily in the memory (the RAM 23), notifying the data-type management part 57 of the converted character string (4-31). The data-type management part 57 notifies each information including the value of the common information ID, the value after the data-type conversion, and the value after the character code conversion, to the common information ID control part 51 (4-31).

The common information ID control part 51 notifies the device information of all the information IDs to the common interface (4-32), and the common interface notifies the device information of all the information IDs to the application program AP (4-33).

Thereby, the application program AP performs appropriate processing (information display etc.) based on the device information of all the acquired information IDs, and calls the DeviceClose processing of the common interface (4-34).

Accordingly, the common interface performs the post-processing within the common interface, and sends a “close” request to the common information ID control part 51 (4-35). The common information ID control part 51 performs the post-processing within the common information ID control part 51, and sends a “close” request to each protocol management part 54 through the protocol control part 53 (4-36 to 4-37).

Each protocol management part 54 performs the post-processing in each protocol management part 54, and reports to the common information ID control part 51 through the protocol control part 53 that the post-processing is finished (4-38 to 4-39).

The common information ID control part 51 notifies the common interface that the post-processing is finished (4-40). The common interface reports to the application program AP that the post-processing is finished (4-41), and the series of the processing of the communication control function is thus finished.

As described above, according to the embodiment 3 of the invention, while the application program AP is not conscious of the difference in the character code by the character encoding scheme processed by the protocol, when acquiring the device information, the character code conversion can be automatically performed only by specifying the common information ID. It is possible to carry out communication with the device, and the burdens of the application program AP can be eased. The difference of the character code in each protocol can be absorbed. The burden placed on the development work at the time of implementing the application program AP can be eased.

### Embodiment 4

In this embodiment, when the value of the device information acquired from each protocol among the device information acquired from a plurality of protocols is a character string, the communication control function for unifying those character codes and processing it will be explained.

The present embodiment differs from the embodiments 1 and 3 only in that a unified character code conversion function is added based on the communication control function of the embodiment 3, the unified character code conversion function converting the character string of the acquired device information into the unified character code.

In the present embodiment, the elements which are the same as corresponding elements in the system configuration of FIG. 1 and the hardware configuration of FIG. 2A and FIG. 2B according to the embodiments 1 and 3 are designated by the same reference numerals, and a description thereof will be omitted. The description will be focused on the contents relevant to the unified character code conversion function different from the embodiment 1.

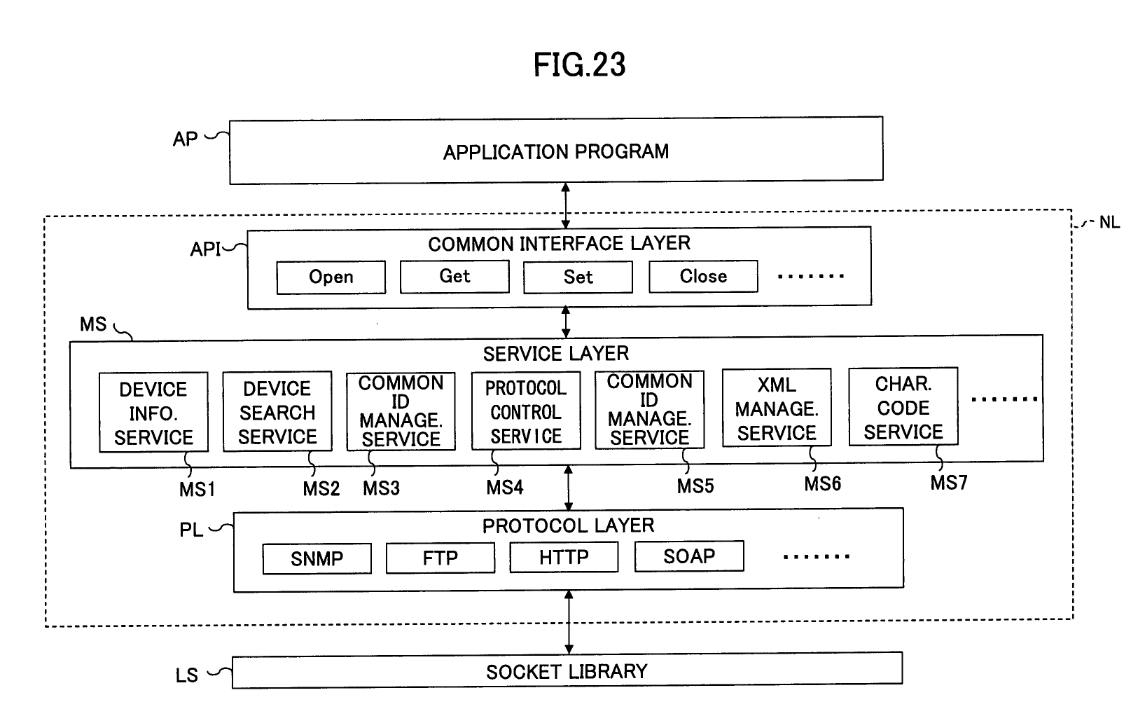

FIG. 23 shows the composition of the network-layer NL concerning the embodiment 4 of the invention.

This network-layer NL is a layer in which the function for offering communication facility (information acquisition, setup, etc.) with a device to the application program AP is implemented. The network-layer NL includes a common interface (common API) layer, a service layer, and a protocol layer.

The common interface (common API) layer API is a layer in which API (Application Program Interface) which offers the abstract interface independent of the classification of the information acquired from a device etc. to the application program AP is implemented.

For example, the function (Open) for starting communication with a device, the function (Get) for acquiring information from device 20, the function (Set) for setting information to device 20, the function (Close) for ending communication with device 20, etc. are implemented.

Each function in the common API layer 13 calls a service layer based on the parameter (classification of information being acquired) and the parameter (time-out etc.) for controlling communication, specified by the application program AP.

The service layer MS is constituted by the module group which offers the function which specialized in each service, such as device information service MS1, device search service MS2, common ID management service MS3, protocol control service MS4, and XML management service MS5.

In this embodiment, the function of character code service MS7 is added to the module group of this service layer MS. The character code service MS7 is a module (management tool which manages a character code acquisition method) which offers functions related to a character code, such as acquisition of a character code, and conversion of a character code.

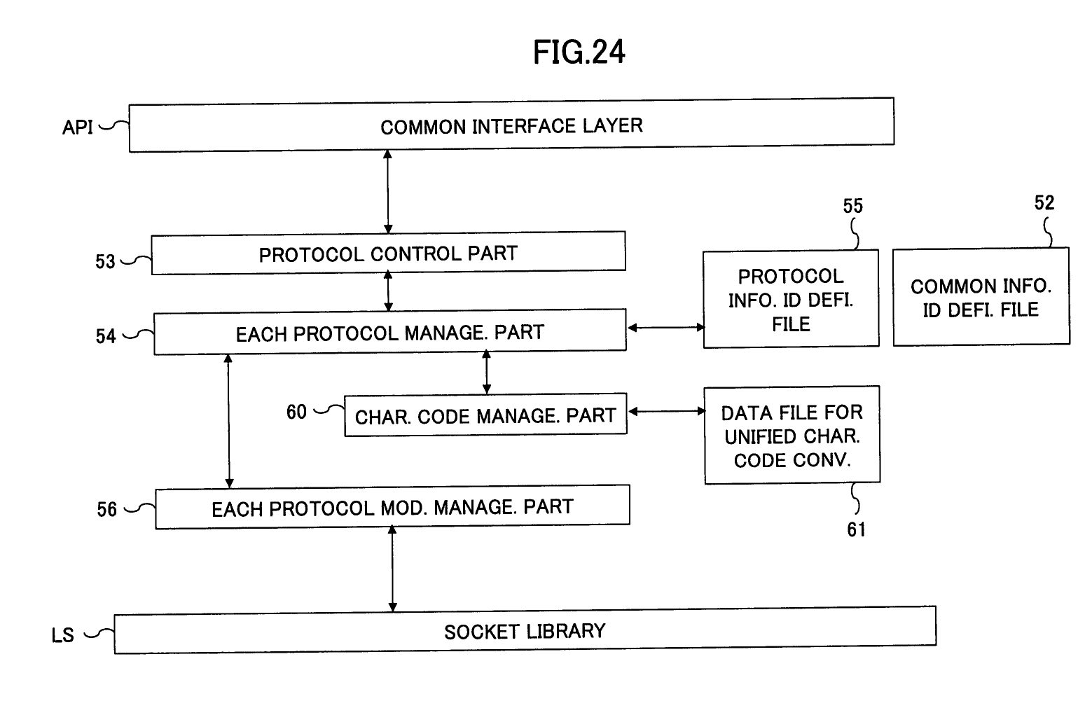

FIG. 24 shows the functional composition of the communication control function concerning the embodiment 4 of the invention.

This communication control function includes, in addition to the common information ID definition file 52, the protocol control part 53, each protocol management part 54, the protocol information ID definition file 55, and each protocol module management part 56, a unified character code conversion part 60, and a data file 61 for unified character code conversion holding the data for unified character code conversion which converts the character string of the acquired device information into the unified character code.

The communication control function of this embodiment aims at performing communication control, without making the application program conscious of the difference in the character code in the protocol.

The data file 61 for unified character code conversion used when converting a character code by the communication control function will be explained.

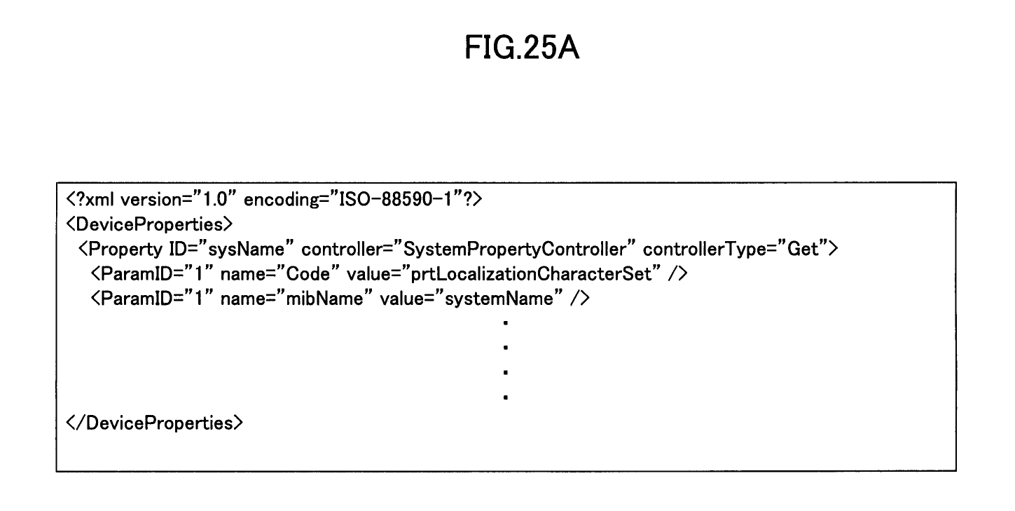

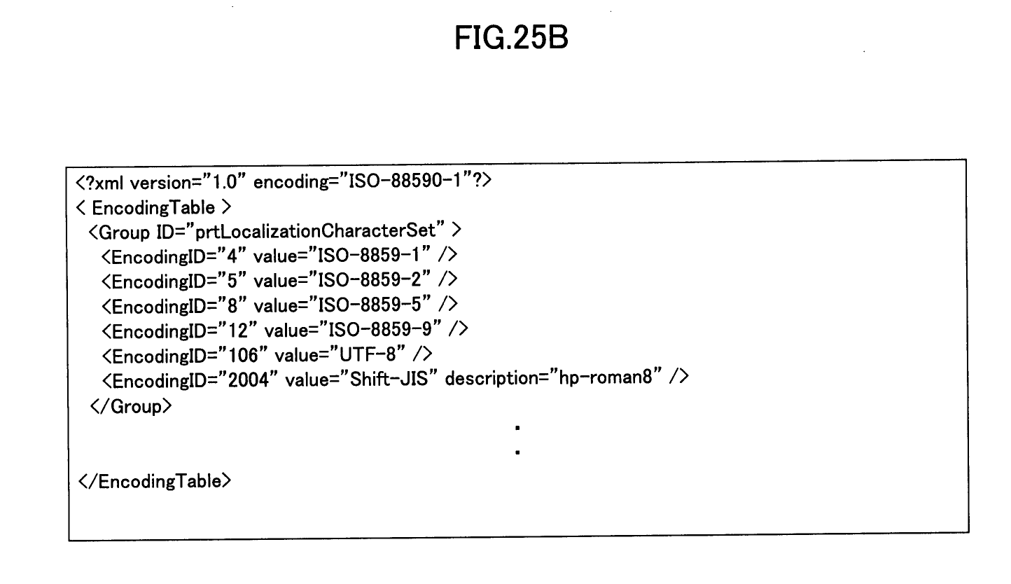

FIG. 25A shows an example of the common information ID definition file (XML file) related to a character code. FIG. 25B shows an example of the XML file related to a character code. The XML file is the data file 61 for unified character code conversion for unifying the character string of the device information acquired from each protocol among the device information acquired from two or more protocols, and enabling it to be processed (character code acquisition method).

When the application program acquires device information, such as a system name, if these files do not report what kind of character encoding scheme the information is, they can consider that a garbled-characters phenomenon occurs.

Then, in order to prevent garbled characters of application, it is desirable to provide the application side with the character code currently used for device information and its information. For example, various protocols are used when acquiring device information. For example, SNMP, SOAP, etc. are typical protocols.

The character code MIB used for each MIB (Management Information Base) is contained in the character code of SNMP.

In the example of FIG. 25A and FIG. 25B, when it is the case of the MIB_II_object name of sysName, it means referring to character code MIB with the value of “prtLocalizationCharacterSet”. The keyword at the time of referring to the character code MIB is expressed with a code. It provides for the application program by setting into the set point a unified character code (refer to URL http://www.iana.org/assignments/character-sets) common to the world for the value of prtLocalizationCharaterSet, in order to maintain compatibility with other protocols. The specific number is assigned in order to identify each character in a character set among the character sets (character sets) it is determined as international standards that could perform information interchange using a computer smoothly as a character code common to the world.

For example, when the value of prtLocalizationCharacterSet is 106, it becomes a character code of UTF-8.

In the SOAP, since the same code as a character code common to the world is set as the value of encoding indicated to XML data, the set point is returned to the application program as it is.

For example, in the case of <?XML Version=“1.0” encoding=“UTF-8”>, UTF-8 is a character code.

In this manner, when returning device information to the application program, the character code (common to the world) unified in the world as a character code of the device information is returned, and it is possible to prevent occurrence of wrong conversion of character code.

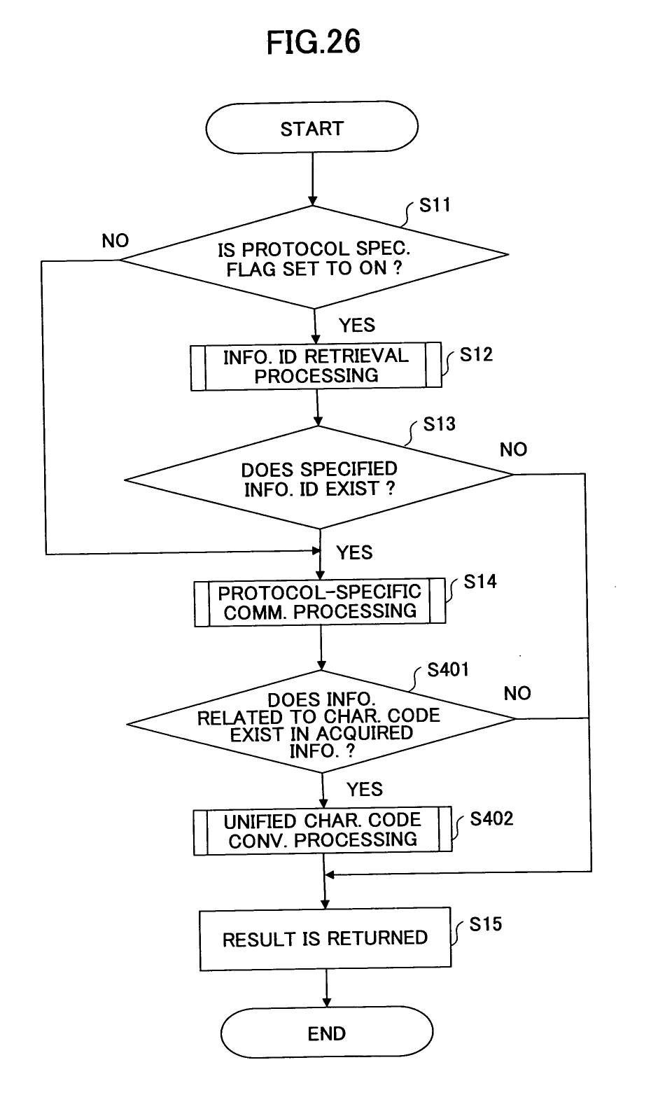

Next, the unified character code conversion part 60 in the communication control function which converts the character string of the acquired device information into the unified character code will be explained using FIG. 26-FIG. 28.

FIG. 26 is a flowchart for explaining DeviceGet( ) in the communication control function concerning the embodiment 4 of the invention.

In the following, DeviceOpen( ), DeviceClose( ), and the protocol-specific communication processing will be explained using FIG. 9A-FIG. 9D.

As shown in FIG. 9A, DeviceOpen( ) determines, when it is called from the application program, whether the protocol specification parameter is specified as the automatic (S1). DeviceOpen( ) sets the protocol specification flag to ON, when the value of protocol specification is specified as the automatic (S2).

Then, initializing processing is performed (S3), and the control is returned to the application program.

The application program specifies information ID of device information to be acquired from the device side, and calls DeviceGet( ) of FIG. 26. DeviceGet( ) determines whether the protocol specification flag is set to ON (S11).

When the protocol specification flag is ON (it is the root of YES at S11), information ID retrieval processing is called based on information ID (S12), and it is searched whether information ID retrieval processing is registered into protocol information ID definition file 55 of each protocol based on information ID (S13). The result is returned to DeviceGet( ).

DeviceGet( ) calls the protocol-specific communication processing based on the protocol and information ID which were detected, when information ID exists (it is the root of YES at S13) (S14).

DeviceGet( ) detects whether the acquired information is a character string to the communication result from the protocol-specific communication processing (S401).

When it is a character string at S401, the unified character code conversion processing is called (402). DeviceGet( ) creates a return value based on a communication result (acquired device information) and a conversion result (unified character code). And the control is returned to the application program (S15).

On the other hand, when the information acquired at step S401 is not a character string, the unified character code conversion processing is not called, but DeviceGet( ) creates a return value based on the communication result (acquired device information) from the protocol-specific communication processing. Then the control is returned to the application program (S15).

When information ID does not exist at step S13, a return value which notifies such information is created, and it is returned to the application program (S15). And the application program calls DeviceClose( ).

DeviceClose( ) performs post-processing of FIG. 9C (S21), and returns the result of the post-processing to the application program. It is detected whether the protocol-specific communication processing is registered into protocol information ID definition file 55 based on information ID, as shown in FIG. 9D (S22). When registered, the information (applicable access method) related to root) of YES and its information ID is acquired by (S22 (S23), communication processing is performed according to the information (S24), and a communication result (acquired device information) is returned to DeviceGet( ) (S25).

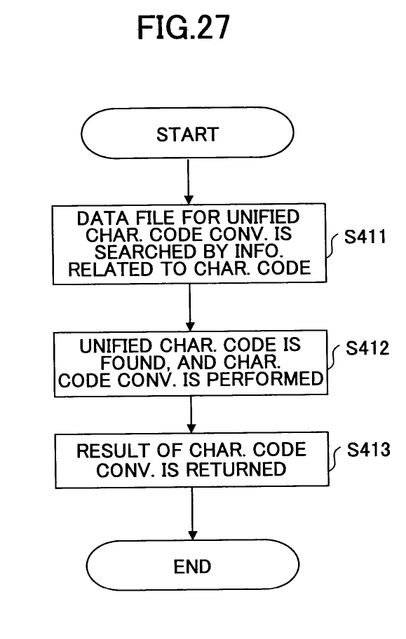

FIG. 27 is a flowchart for explaining the unified character code conversion processing in the communication control function concerning the embodiment 4 of the invention.

The unified character code conversion processing makes reference to the data file for unified character code conversion based on the information related to the acquired character code (S411), and converts the character code into the corresponding unified character code (S412). And a conversion result (unified character code) is returned to DeviceGet( ) (S413).

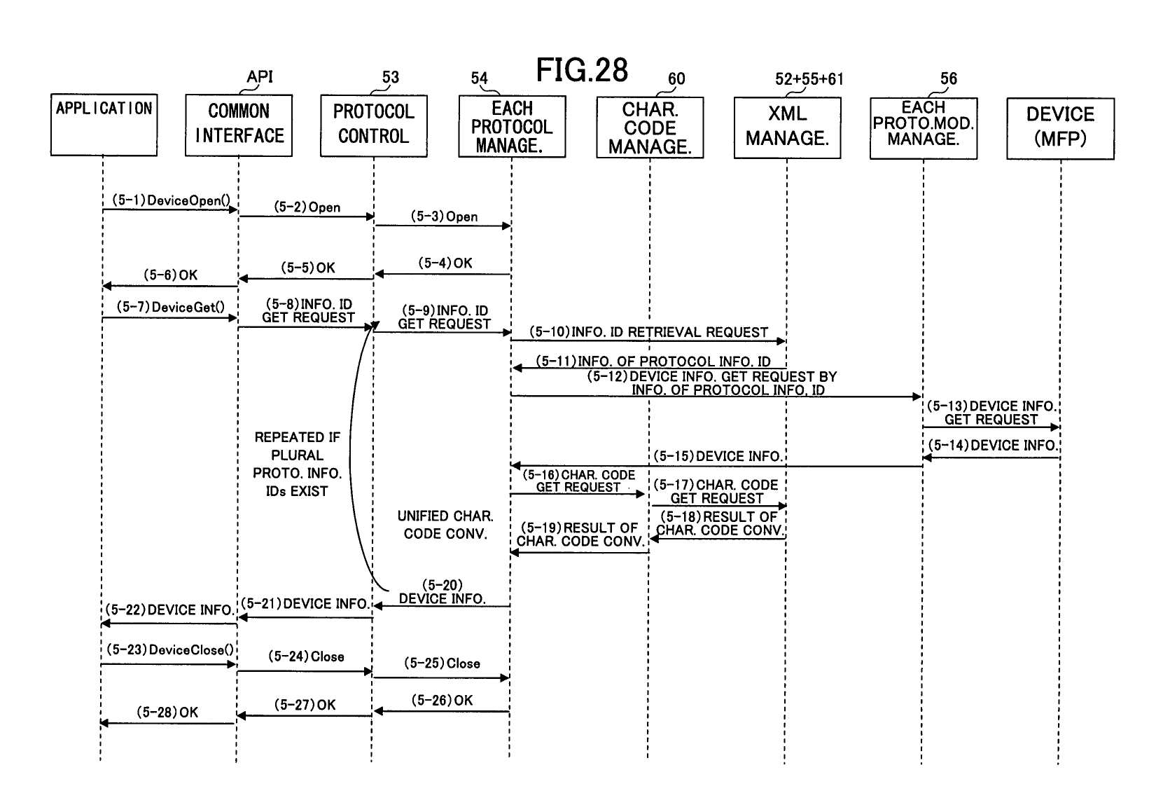

FIG. 28 shows an example of the procedure of the communication control function concerning the embodiment 4 of the invention.

As shown in FIG. 28, the application program AP calls the Open function of common interface (5-1). By this, the common interface sends an Open request to each protocol management part 54 through the protocol control part 53 (5-2 to 5-3). Each protocol management part 54 performs initialization processing of each protocol, and notifies to the common interface management through the protocol control part 53 that processing of the Open request is finished (5-4 to 5-5).

If the common interface is notified from the protocol control part 53, it notifies the application program AP that processing of the Open request is finished (5-6).

Next, in order to acquire device information, the application program AP requests the common interface by calling DeviceGet( ) with the argument (parameter) including the information ID related to the device information being acquired (5-7). The common interface requests information ID related to device information being acquired to each protocol management part 54 through the protocol control part 53 (5-8 to 5-9). Each protocol management part 54 requests to the XML management that information ID should be searched in the XML form information ID definition files 52 and 55 based on the requested information ID related to each ID of information ID related to the device information requested by the common interface (5-10).

The XML management acquires the information related to information ID from the common information ID definition file (refer to FIG. 25A) related to a character code, and notifies each protocol management part 54 of it (5-11). For example, when the information ID is sysName and the acquired device information is a device name, what is acquired from the common information ID definition file is as follows.

<Property ID=“sysName”,

controller=“StringPropertyController”,

controllerType=“Get”>,

<Param ID=“1”, name=“Code”,

value=“prtLocalizationCharacterSet”/>, and

<Param ID=“1”, name=“mibName”, value=“sysName”>”.

In the acquired information, “Property ID” denotes an information ID name, “controller” denotes the control function name inside network-layer NL, and “controllerType” denotes a processing operation outline (“Get” means “acquisition”).

Moreover, “Param ID” denotes various protocol information, “name” denotes the descriptor inside the network-layer NL, and “Value” denotes the information related to the contents of a protocol. “Code” is the information related to a character code. The information source of the character code is expressed with MIB object ID of prtLocalizationCharacterSet. “mibName” is an MIB object name. The information source of “sysName” is expressed with MIB object ID of sysName.

Each protocol management 54 notifies each protocol module management part 56 of the information acquired from XML management (5-12). Each protocol module management 56 notifies to the module of the specified protocol name based on the information acquired from XML management, so that the device information is acquired from the device side, and notifies the result to each protocol management part 54 (5-13 to 5-15). For example, the value of MIB object ID of sysName and prtLocalizationCharacterSet is acquired from the device side.

Subsequently, each protocol management part 54 notifies the character code management part 60 of the information of a character code (information related to prtLocalizationCharacterSet), when the information related to character code (Code) is contained in the acquired information (5-16).

The character code management part 60 notifies conversion to a unified character code to the XML management based on the information of a character code (5-17). The expression of the information of the character code notified by the character code management part 60 differs according to the protocol, such as ID and a cable address.

For example, in the case of the SNMP, the value of prtLocalizationCharacterSet of Printer-MIB is expressed with the MIBenum number (ID) of the character code (refer to URL: http://www.iana.org/assignments/character-sets) common to the world. On the other hand, in the case of Shift JIS, it is expressed by 17 or 2024.

In the SOAP, the parameter “encoding” indicated in the XML data denotes the character code. When the XML data is <?XML Version=“1.0” encoding=“UTF-8”>, “UTF-8” denotes the character code.

In this manner, the information of the character code which differs according to each protocol is converted into the unified character code, and a conversion result is returned.

The XML management coverts the character code into the unified character code based on the information of the character code, and notifies the character code management part 60 of the conversion result (unified character code) (5-18).

For example, when the character code is returned as the MIBenum number and the “encoding” indicated in the XML data denotes “UTF-8”, “UTF-8” is converted into “106” by making reference to the data file 61 for unified character code conversion of FIG. 25B with the “UTF-8” as the search key.

The character code management part 60 notifies each protocol management part 54 of the unified character code (5-19). Each protocol management part 54 notifies the device information and the unified character code to the common interface through the protocol control part 53 (5-20 to 5-21). The common interface notifies the device information and the unified character code to the application program AP (5-22).

And the application program AP sends a Close request to the common interface (5-23). The common interface sends a Close request to each protocol management part 54 through the protocol control part 53 (5-24 to 5-25). Each protocol management part 54 performs the post-processing within each protocol management part 54, and reports to the common interface through the protocol control part 53 that the post-processing is finished (5-26 to 5-27).

Thereby, the common interface notifies the application program AP that the post-processing is finished (5-30).

As described above, according to the embodiment 4 of the invention, while it is not necessary for the application program AP to acquire a character code when acquiring device information, and the application program AP is conscious of the difference in the character code by the character encoding scheme processed by the protocol, it is possible to carry out communication with a device and the burdens of the application program AP can be eased.

### Embodiment 5

In this embodiment, even when the value of the device information acquired from each protocol among device information acquired from a plurality of protocols is a character string, and there is no information related to the character code of the character string, the communication control function enables the processing to be performed.

What this embodiment differs from the embodiments 1 and 3 is that a character code analysis function which analyzes a character code related to the character string of the acquired device information based on the communication control function of the embodiment 3 is added. Other elements which are essentially the same as those corresponding elements in the system configuration of FIG. 1 concerning the embodiments 1 and 3 and the hardware configuration of FIG. 2A and FIG. 2B are designated by the same reference numerals, and a description thereof will be omitted.

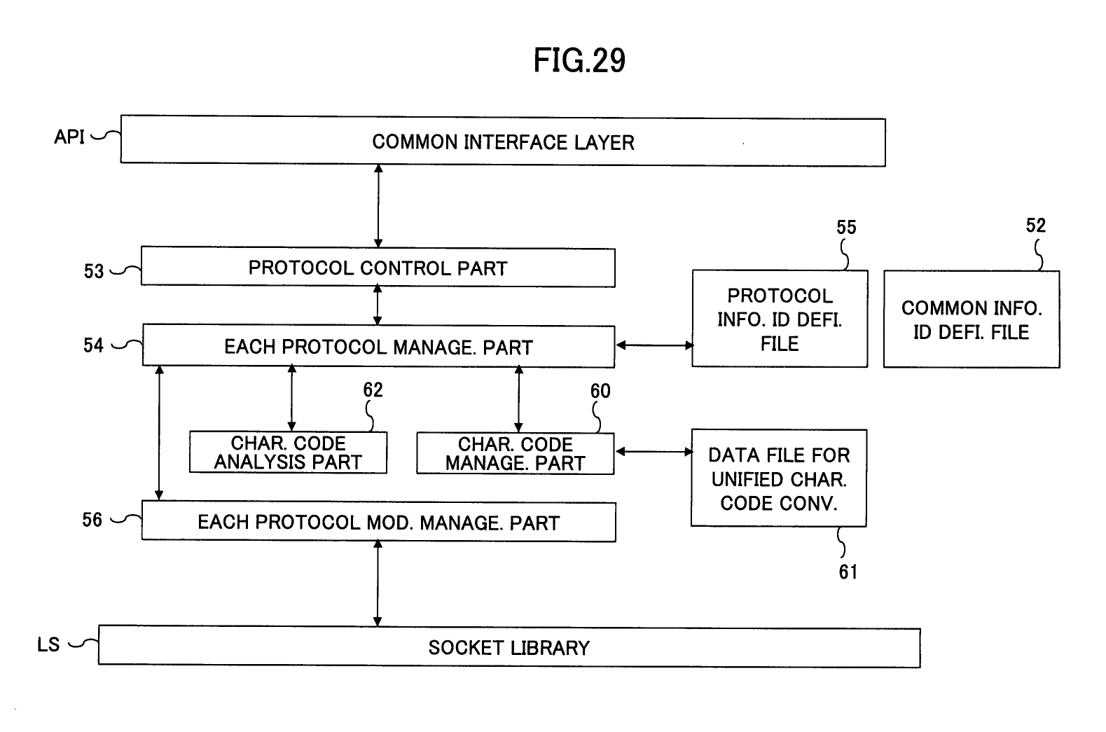

FIG. 29 shows the functional composition of the communication control function concerning the embodiment 5 of the invention.

This communication control function includes, in addition to the common information ID definition file 52, the protocol control part 53, each protocol management part 54, the protocol information ID definition file 55, each protocol module management part 56, the unified character code conversion part 60 and the data file 61 for unified character code conversion, a character code analysis part 62 which analyzes the character code of the character string of the acquired device information.

Even when there is no information related to the character code of the character string of the device information acquired from each protocol, the communication control function of this embodiment is aimed at performing communication control without making the application program conscious of the difference in the character code in a protocol.

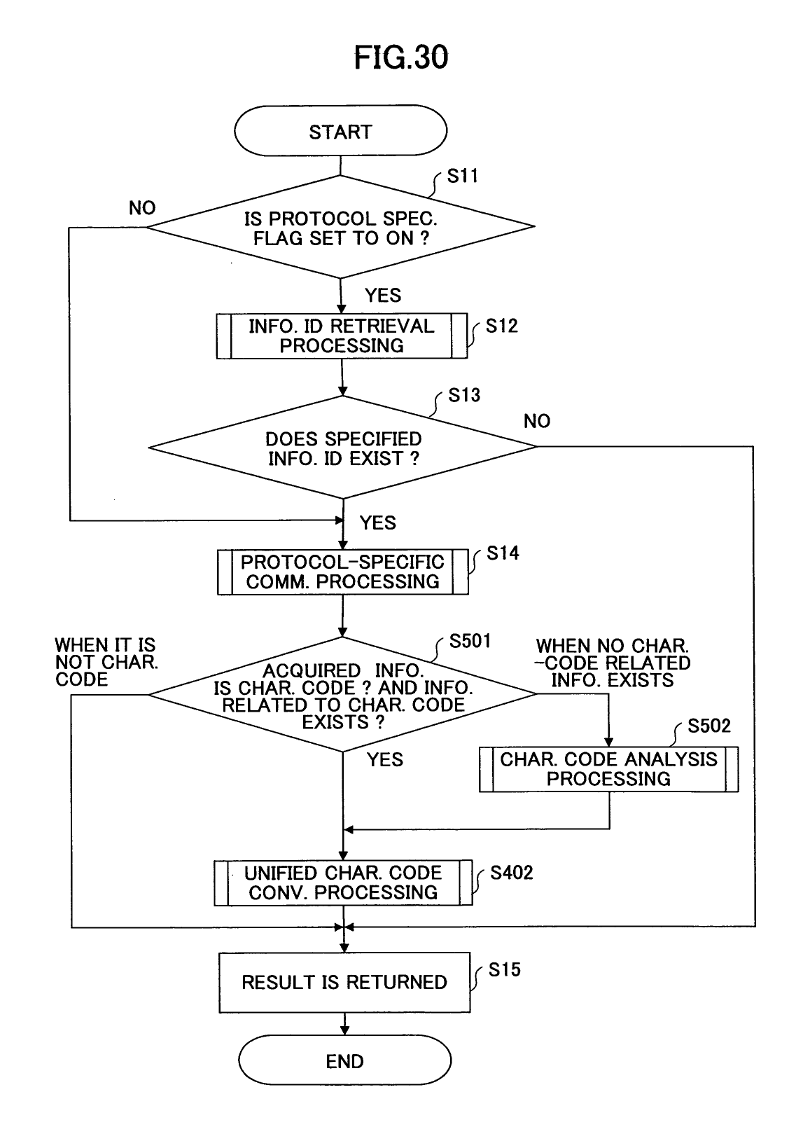

Next, the unified character code conversion part 60 in the communication control function, the unified character code conversion part, the unified character code conversion part 60 converting into the unified character code the character string of the acquired device information, will be explained with reference to FIGS. 30-32.

FIG. 30 is a flowchart for explaining DeviceGet( ) in the communication control function concerning the embodiment 5 of the invention.

In the following, DeviceOpen( ), DeviceClose( ), and the protocol-specific communication processing will be explained using FIG. 9A-FIG. 9D.

As shown in FIG. 9A, DeviceOpen( ) determines, when called from the application program, whether the protocol specification parameter is specified as the automatic (S1). When the value of the protocol specification is specified as the automatic at S1, DeviceOpen( ) sets the protocol specification flag to ON (S2).

Then, DeviceOpen( ) performs initializing processing (S3), and the control is returned to the application program.

The application program calls DeviceGet( ) of FIG. 30 by specifying information ID of device information being acquired from the device side. DeviceGet( ) determines whether the protocol specification flag is set to ON (S11).

When the protocol specification flag is set to ON at S11, the information ID retrieval processing is called based on the information ID (S12). It is detected by the information ID retrieval processing based on the information ID whether the information ID is registered in the protocol information ID definition file 55 of each protocol (S13). The result is returned to DeviceGet( ).

When the information ID exists at S13, DeviceGet( ) calls the protocol-specific communication processing based on the protocol and the detected information ID (S14).

Based on the communication result from the protocol-specific communication processing, DeviceGet( ) detects whether the acquired information is a character string and detects whether there is any information related to the character code (S501).

When the acquired information is a character string and there is information related to the character code at S501, DeviceGet( ) calls the unified character code conversion processing (402). DeviceGet( ) creates a return value based on the communication result (acquired device information) and the conversion result (unified character code), and the control is returned to the application program (S15).

On the other hand, when the information acquired at step S501 is not a character string, the unified character code conversion processing is not called, but DeviceGet( ) creates a return value based on the communication result (acquired device information) from the protocol-specific communication processing, and the control is returned to the application program (S15).

When the information acquired at step S501 is a character string and there is no information related to the character code, DeviceGet( ) calls the character data analysis processing (S502), and performs the unified character code conversion processing based on the analysis result (information of the character code) after the analysis processing of S402 is completed. DeviceGet( ) creates a return value based on the conversion result from the unified character code conversion processing, and returns it to the application program (S15).

When information ID does not exist at step S13, DeviceGet( ) creates a return value which notifies such a result, and returns it to the application program (S15). And the application program calls DeviceClose( ).

DeviceClose( ) performs the post-processing of FIG. 9C (S21), and returns the result to the application program.

It is detected through the protocol-specific communication processing whether the information ID is registered in the protocol information ID definition file 55 based on the information ID, as shown in FIG. 9D (S22).

When it is registered at S22, the information (access method) related to the information ID is acquired (S23), the communication processing is performed according to the information (S24), and a communication result (acquired device information) is returned to DeviceGet( ) (S25).

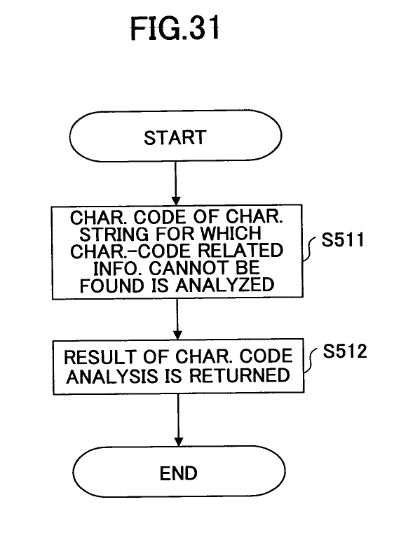

FIG. 31 is a flowchart for explaining the character code analysis processing in the communication control function concerning the embodiment 5 of the invention.

The character code analysis processing analyzes a character code to the character string of the acquired device information (S511), and returns an analysis result (character code after analysis) to DeviceGet( ) (S512).

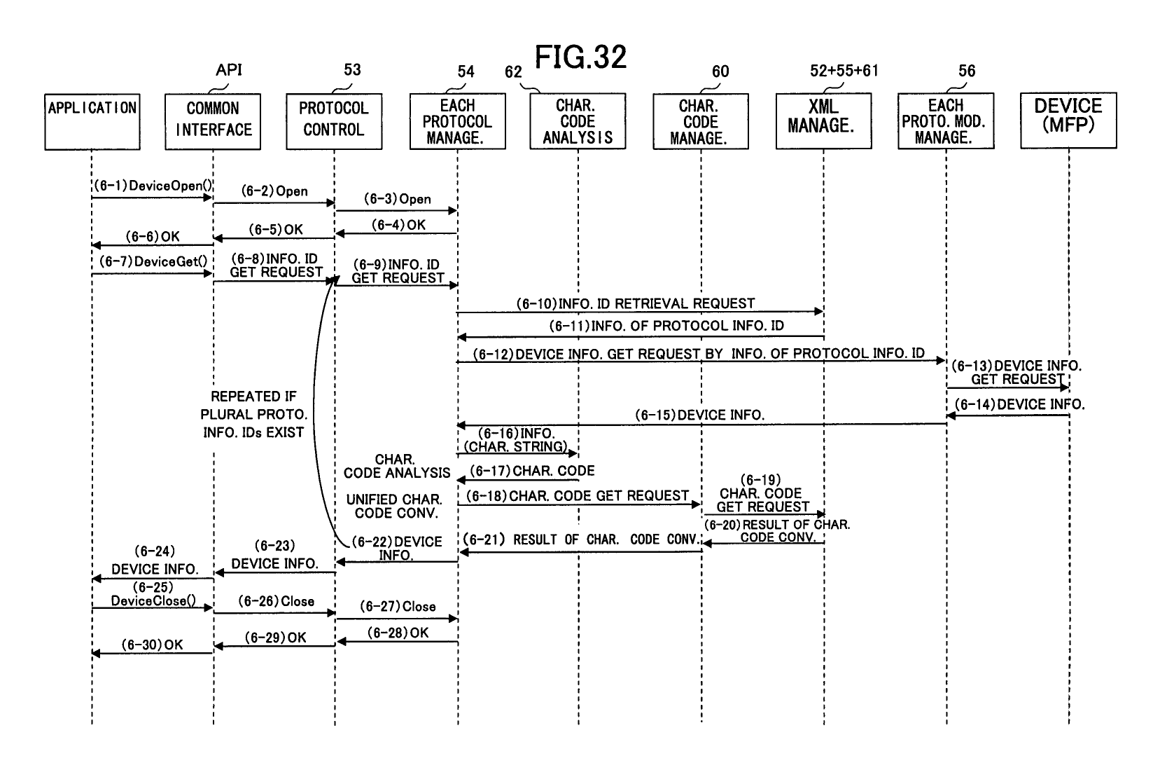

FIG. 32 shows an example of the procedure of the communication control function concerning the embodiment 5 of the invention.

As shown in FIG. 32, the application program AP calls the Open function of the common interface (6-1). By this, the common interface sends an “open” request to each protocol management part 54 through the protocol control part 53 (6-2 to 6-3). Each protocol management part 54 performs initialization processing of each protocol and notifies to the common interface management through the protocol control part 53 that the “open” request processing is finished (6-4 to 6-5).

When the common interface is notified from the protocol control part 53, the common interface notifies the application program AP that processing of the Open request is finished (6-6).

Next, in order to acquire device information, the application program AP requests the common interface by calling DeviceGet( ) with the argument (parameter) including information ID related to device information being acquired (6-7).

The common interface sends, to each protocol management part 54 through the protocol control part 53, a request for acquisition of the information ID related to the device information (6-8 to 6-9). Each protocol management part 54 requests the XML management that the information ID should be searched in the XML-form information ID definition files 52 and 55 based on the information ID related to each ID of the information ID related to the device information requested from the common interface (6-10).

The XML management acquires the information related to the information ID from the common information ID definition file (refer to FIG. 25A) related to a character code, and notifies each protocol management part 54 of it (6-11).

Each protocol management 54 notifies each protocol module management part 56 of the information acquired from the XML management (6-12). Each protocol module management 56 acquires device information from the device side, with respect to the module of the protocol name specified based on the information acquired from the XML management, and notifies it to each protocol management part 54 (6-13 to 6-15).

For example, each protocol module management 56 acquires the values of MIB object ID of sysName and prtLocalizationCharacterSet from the device side.

At this time, each protocol management part 54 detects whether the information related to the character code is included in the acquired information. When the information related to a character code is not included, each protocol management part 54 notifies the device information (character string) to the character code analysis part 62 (6-16).

The character code analysis part 62 analyzes the character code currently described in the device information, and notifies an analysis result (information of the character code) to each protocol management part 54 (6-17). Each protocol management part 54 notifies the analysis result to the character code management 60 (6-18).

When it is detected that the information related to the character code is included in the acquired information, each protocol management part 54 notifies the information of the acquired character code to the character code management part 60 (6-18).

The character code management part 60 sends a request for conversion to the unified character code to the XML management based on the information of the character code (6-19).

The XML management performs the conversion into the unified character code based on the information of the character code, and notifies a conversion result (unified character code) to the character code management part 60 (6-20). For example, when the character code is returned as a MIBenum number and the “encoding” indicated in the XML data denotes “UTF-8”, “UTF-8” is converted into 106 by making reference to the data file 61 for unified character code conversion of FIG. 25B with the key “UTF-8”.

The character code management part 60 notifies each protocol management part 54 of the unified character code (6-21). Each protocol management part 54 notifies the device information and the unified character code to the common interface through the protocol control part 53 (6-22 to 6-23). The common interface notifies the device information and the unified character code to the application program AP (6-24).

And the application program AP sends a Close request to the common interface (6-25). The common interface sends a Close request to each protocol management part 54 through the protocol control part 53 (6-26 to 6-27). Each protocol management part 54 performs the post-processing within each protocol management part 54, and reports to the common interface through the protocol control part 53 that the post-processing is finished (6-28 to 6-29).

Thereby, the common interface notifies the application program AP that the post-processing is finished (6-30).

As described above, according to the embodiment 5 of the invention, while it is not necessary for the application program AP to acquire a character code when acquiring device information, and the application program AP is not conscious of the difference in the character code by the character encoding scheme processed by the protocol, it is possible to carry out communication with a device and the burdens of the application program AP can be eased.

Since the character code is distinguished from the character string of the device information, it is not necessary to perform processing which distinguishes the character code. Since the difference of the character code in each protocol can be absorbed, the burden placed on the development work at the time of implementing the application program AP can be eased.

### Embodiment 6

In this embodiment, the communication control functions of the embodiments 3, 4 and 5 described above are combined, and the communication control function is to convert into an appropriate character code the character string which is the value of device information.

In the communication control function of this embodiment, the character code conversion processing of the embodiment 3, the unified character code conversion processing of the embodiment 4, and the character code analysis processing of the embodiment 5 are combined, the unified character code conversion or character code analysis processing is performed with respect to the character string of the acquired device information, and the character code conversion processing is used based on the conversion or analysis result, to convert the character code into the unified character code.

Therefore, the elements which are essentially the same as corresponding elements in the system configuration of FIG. 1 and the hardware configuration of FIG. 2A and FIG. 2B used in the description of the embodiments 1, 3, 4 and 5 are designated by the same reference numerals, and a description thereof will be omitted.

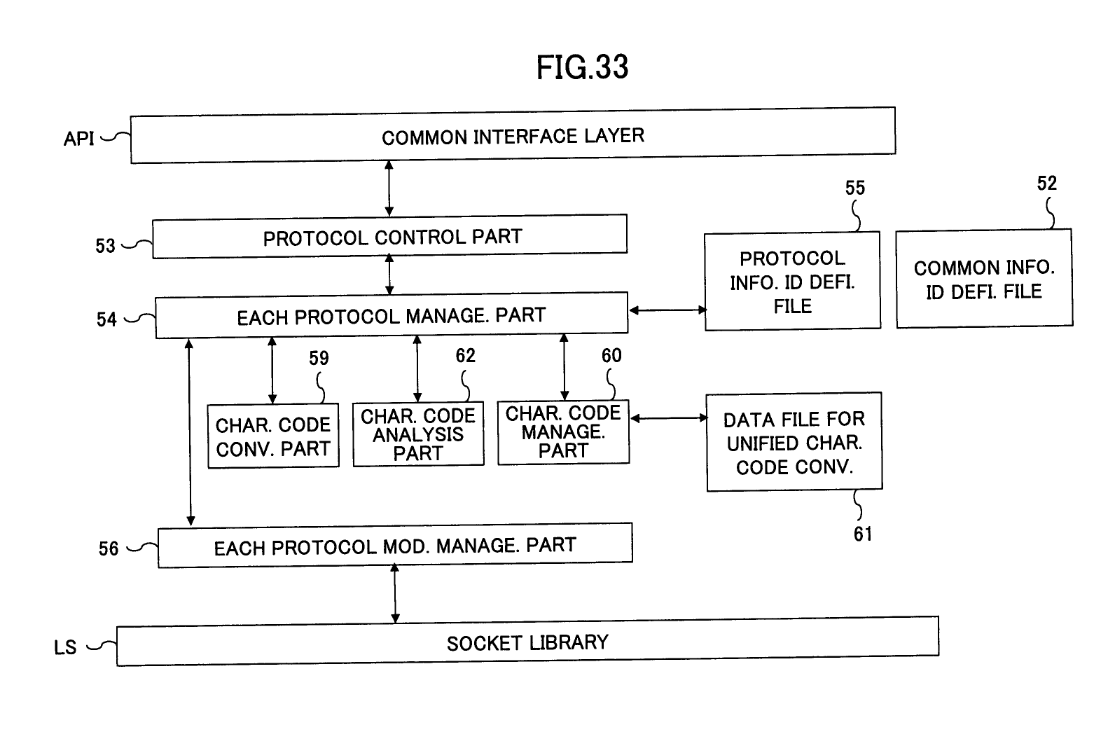

FIG. 33 shows the functional composition of the communication control function concerning the embodiment 6 of the invention.

This communication control function includes the common information ID definition file 52, the protocol control part 53, each protocol management part 54, the protocol information ID definition file 55, each protocol module management part 56, the character code conversion part 59, the unified character code conversion part 60, the data file 61 for unified character code conversion, and the character code analysis part 62. And the communication control function of this embodiment is aimed at performing the communication control, without making the application program conscious of the difference in the character code in the protocol.

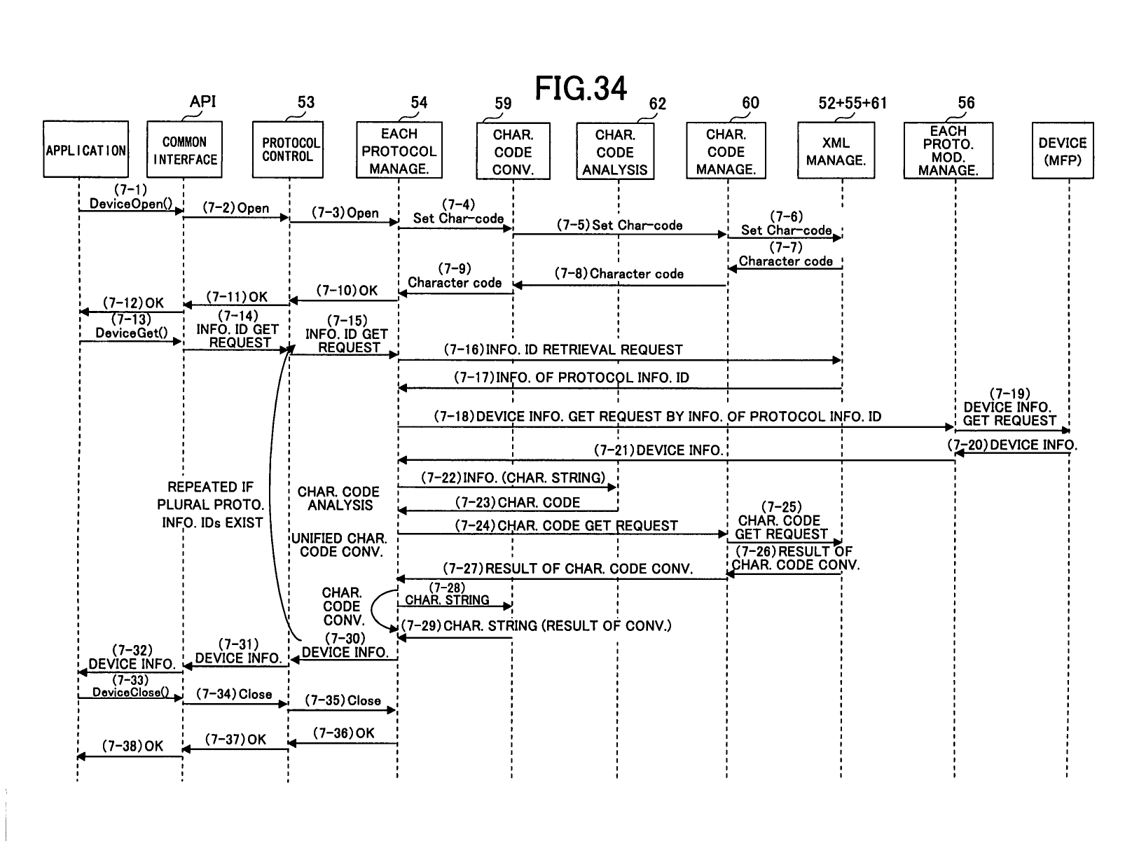

FIG. 34 shows an example of the procedure of the communication control function concerning the embodiment 6 of the invention.

As shown in FIG. 34, the application program AP calls the Open function of the common interface (7-1). By this, the common interface sends an “open” request to each protocol management part 54 through the protocol control part 53 (7-2 to 7-3). Each protocol management part 54 performs initialization processing of each protocol, and when there is a character code specified by the application program AP, each protocol management part 54 notifies the specified character code to the character code conversion part 59 (7-4).

In order to detect whether the specified character code exists, the character code conversion part 59 notifies the specified character code to the character code management part 61 (7-5). The character code management part 61 notifies the specified character code to the XML management (7-6).

The XML management makes reference to the common information ID definition file (see FIG. 25A) with respect to the character code, determines whether the specified character code exists, and notifies a result of the determination the character code management part 61 (7-7). The character code management part 61 notifies the result of the determination to the character code conversion part 59 (7-8). The character code conversion part 59 notifies the result of the determination to each protocol management part 54 (7-9).

Each protocol management par 54 performs initialization processing of each protocol, and notifies to the common interface management through the protocol control part 53 that the open request processing is finished (7-10 to 7-11).

When the common interface is notified from each protocol management part 54, the common interface reports to the application program that the open request processing is finished (7-12).

Next, in order to acquire device information, the application program AP sends an acquisition request to the common interface by calling DeviceGet( ) with the argument (parameter) including the information ID related to the device information being acquired (7-13).

The common interface sends, to each protocol management part 54 through the protocol control part 53, the acquisition request for acquiring the information ID related to the device information (7-14 to 7-15). Each protocol management part 54 requests the XML management that, based on the requested information ID, the XML-form information ID definition files 52 and 55 should be retrieved based on the requested information ID, for each ID of the information ID related to the device information requested by the common interface (7-16).

The XML management acquires the information related to the information ID from the common information ID definition file (see FIG. 25A) related to the character code, and notifies each protocol management part 54 of it (7-17).

Each protocol management part 54 notifies each protocol module management part 56 of the information acquired from the XML management (7-18). Each protocol module management part 56 acquires the device information from the device side, with respect to the module of the protocol name specified based on the information acquired from the XML management, and notifies it to each protocol management part 54 (7-19 to 7-21).

At this time, each protocol management part 54 determines whether the information related to the character code is included in the acquired information. When the information related to a character code is not included, each protocol management part 54 notifies the device information (character string) to the character code analysis part 62 (7-22).

The character code analysis part 62 analyzes the character code currently described in the device information, and notifies each protocol management part 54 of an analysis result (character code information) (7-23).

Each protocol management part 54 notifies the character code management part 60 of the analysis result (7-24).

On the other hand, when it is determined that the information related to the character code is included in the acquired information, each protocol management part 54 notifies the character code management par 60 of the information of the acquired character code (7-24).

The character code management part 60 requests the conversion to the unified character code to the XML management based on the information of the character code (7-25).

The XML management performs the conversion into the unified character code based on the information of the character code, and notifies the character code management part 60 of a conversion result (unified character code) (7-26). For example, when the character code is returned as the MIBenum number and the “encoding” indicated in the XML data is “UTF-8”, “UTF-8” is converted into 106 by making reference to the data file 61 for unified character code conversion of FIG. 25B with the key “UTF-8”.

The character code management part 60 notifies each protocol management part 54 of the unified character code (7-27). Each protocol management part 54 notifies the device information and the unified character code to the character code conversion part 59 (7-28).

The character code conversion part 59 compares the pre-defined character code and the character code which is the analysis result from the character code analysis part 62.

When the two character codes are different, the device information and the unified character code are converted into the specified character codes, and each protocol management part 54 is notified of the device information and the specified character code which are the result of the conversion (7-29).

When the character code which is the analysis result matches with the predefined character code, the character code conversion is not performed.

Each protocol management part 54 notifies the device information, which is the result of the conversion, and the specified character code to the common interface through the protocol control part 53 (7-30 to 7-31). The common interface notifies the device information and the unified character code to the application program AP (7-32).

The application program AP sends a close request to the common interface (7-33). The common interface sends a close request to each protocol management part 54 through the protocol control part 53 (7-34 to 7-35). Each protocol management part 54 performs the post-processing in each protocol management part 54, and reports to the common interface through the protocol control part 53 that the post-processing is finished (7-36 to 7-37).

Thereby, the common interface notifies the application program AP that the post-processing is finished (7-38).

As described above, according to the embodiment 6 of the invention, while it is not necessary for the application program AP to acquire a character code when acquiring device information, the application program is not conscious of the difference in the character code by the character encoding scheme processed by the protocol. Since the character code conversion is performed automatically, it is possible to carry out communication with a device, and the burdens of the application program AP can be eased.

Since the character code is distinguished from the character string of device information, it is not necessary to perform processing which distinguishes the character code.

Since the difference of the character code in each protocol can be absorbed, the burden placed on the development work at the time of implementing the application program AP can be eased.

Although the case where the invention is applied to the network system as shown in FIG. 1 has been described, the invention is applicable similarly related to the other proper communication control devices. The communication control function of the invention functions by causing the CPU 21 to execute (data processing) a computer-readable program which is designed and developed to include the communication control program procedures in the embodiments 1-6. The computer-readable program can be stored in a computer-readable storage medium which is provided in any of the information processing devices WS1-WSn having the CPU 21, such as a computer, and the program can be read from the storage medium.

The present invention is not limited to the above-described embodiments, and variations and modifications may be made without departing from the scope of the present invention.

Further, the present application is based on and claims the benefit of priority of Japanese patent application No. 2005-261622, filed on Sep. 9, 2005, Japanese patent application No. 2005-261623, filed on Sep. 9, 2005, Japanese patent application No. 2005-270669, filed on Sep. 16, 2005, and Japanese patent application No. 2006-240976, filed in Sep. 6, 2006, the entire contents of which are hereby incorporated by reference.

What is claimed is:

1. A communication control device comprising:
a communication control interface performing a communication control adapted for an application program;
a common information ID control part performing management and control of a common information ID;
a common information ID XML file storing information of the common information ID;
a protocol control part performing management and control of each protocol ID and a communication control of a protocol;
a protocol information ID XML file storing information of an information ID for each protocol;
a communication library performing a communication control with an external device; and
a control unit controlling the whole communication control device.

2. The communication control device according to claim 1 wherein the control unit is adapted so that, when a protocol is predetermined, an information ID specified by the application program as information being acquired from the device is received,
wherein the protocol control part detects whether the specified information ID is registered in the protocol information ID XML file, and acquires information of the specified information ID from the protocol information ID XML file when the specified information ID is registered, so that a communication processing with the device is performed according to the information ID.

3. The communication control device according to claim 1 wherein the control unit is adapted so that, when a protocol is predetermined, a common information ID specified by the application program as information being acquired from the device is received,
wherein the common information ID control part detects whether the specified common information ID is registered in the common information ID XML file, and acquires information of the specified common information ID from the common information ID XML file when the specified common information ID is registered, and
wherein the protocol control part detects whether an information ID which is specified based on the common information ID is registered in the protocol information ID XML file, and acquires information of the specified information ID from the protocol information ID XML file when the specified information ID is registered, so that a communication processing with the device is performed according to the information ID.

4. The communication control device of claim 1 wherein each protocol information ID described in the common information ID includes a priority.

5. A communication control method for use in a communication control device including a communication control interface performing a communication control for each application program, a common information ID control part performing management and control of a common information ID, a common information ID XML file storing information of the common information ID, a protocol control part performing management and control of each protocol ID and a communication control of a protocol, a protocol information ID XML file storing information of an information ID for each protocol, a communication library performing a communication control with an external device, and a control unit controlling the whole communication control device, the communication control method comprising the steps of:
receiving an information ID specified by the application program as information being acquired from the device, when a protocol is predetermined;
detecting whether the specified information ID is registered in the protocol information ID XML file; and
acquiring information of the specified information ID from the protocol information ID XML file when the specified information ID is registered, so that a communication processing with the device is performed according to the information ID.

6. The communication control method according to claim 5 wherein the receiving step is configured to receive a common information ID specified by the application program as information being acquired from the device, and include detecting whether the specified common information ID is registered in the common information ID XML file, and acquiring information of the specified common information ID from the common information ID XML file when the specified common information ID is registered, and
wherein the detecting step is configured to detect whether an information ID which is specified based on the common information ID is registered in the protocol information ID XML file, and the acquiring step is configured to acquire information of the specified information ID from the protocol information ID XML file when the specified information ID is registered, so that a communication processing with the device is performed according to the information ID.

7. The communication control method according to claim 5 wherein each protocol information ID described in the common information ID includes a priority.

8. A computer-readable program which, when executed by a computer, causes the computer to perform the communication control method according to claim 5.

9. A computer-readable storage medium on which the computer-readable program according to claim 8 is stored.

10. A communication control device which is adapted to perform communication using a communication device and a plurality of protocols, comprising:
a common information ID control part performing management and control of identification information common to each protocol; and
a data-type management part performing management of a data type specific to each protocol,
wherein, when a request for connection with the communication device sent from an application program by specifying identification information of a protocol is received, the common information ID control part accesses the communication device by using the protocol corresponding to the specified identification information, acquires device information from the communication device, and returns a result of processing of the device information by the data-type management part, to the application program.

11. The communication control device according to claim 10 further comprising a character code conversion part, wherein the character code conversion part receives the result of processing of the device information by the data-type management part, converts the received device information into information of a predetermined character code, and returns the information of the predetermined character code after the conversion to the application program.

12. A computer-readable program which, when executed by a computer, causes the computer to perform a communication control method for use in a communication control device adapted to perform communication using a communication device and a plurality of protocols, the communication control device including a common information ID control part performing management and control of identification information common to each protocol, and a data-type management part performing management of a data type specific to each protocol, the communication control method comprising the steps of:
accessing, when a request for connection with the communication device sent from an application program by specifying identification information of a protocol is received at the common information ID control part, the communication device by using the protocol corresponding to the specified identification information;
acquiring device information from the communication device; and
returning a result of processing of the device information by the data-type management part, to the application program.

13. A computer-readable storage medium on which the computer-readable program according to claim 12 is stored.

14. The communication control device according to claim 10 further comprising an XML management part performing management of a character code access method corresponding to each protocol by using an XML file,
wherein, when the device information acquired from the communication device in response to the request from the application program is a character string, the common information ID control part acquires a character code related to the protocol used when acquiring the device information according to the character code access method, and returns the acquired device information and the acquired character code to the application program.

15. The communication control device according to claim 10 further comprising an XML management part performing management of a character code access method corresponding to each protocol by using an XML file,
wherein, when the device information acquired from the communication device in response to the request from the application program is a character string, the common information ID control part determines a character code based on the acquired character string, and returns the determined character code and the acquired device information to the application program.

16. The communication control device according to claim 10 further comprising an XML management part performing management of a character code access method corresponding to each protocol by using an XML file,
wherein, when the device information acquired from the communication device in response to the request from the application program is a character string, the common information ID control part determines a character code based on the acquired character string, performs conversion of the determined character code when the determined character code is different from a predetermined character code sent from the application program, and returns the acquired device information to the application program.

17. The computer-readable program according to claim 12 wherein the communication control device further includes an XML management part performing management of a character code access method corresponding to each protocol by using an XML file, the communication control method comprising the steps of:
acquiring, when the device information acquired from the communication device in response to the request from the application program is a character string, a character code related to the protocol used when acquiring the device information according to the character code access method; and
returning the acquired device information and the acquired character code to the application program.

18. The computer-readable program according to claim 12 wherein the communication control device further includes an XML management part performing management of a character code access method corresponding to each protocol by using an XML file, the communication control method comprising the steps of:
determining, when the device information acquired from the communication device in response to the request from the application program is a character string, a character code based on the acquired character string; and
returning the determined character code and the acquired device information to the application program.

19. The computer-readable program according to claim 12 wherein the communication control device further includes an XML management part performing management of a character code access method corresponding to each protocol by using an XML file, the communication control method comprising the steps of:
determining, when the device information acquired from the communication device in response to the request from the application program is a character string, a character code based on the acquired character string;
performing conversion of the determined character code when the determined character code is different from a predetermined character code sent from the application program; and
returning the acquired device information to the application program.

20. A computer-readable storage medium on which the computer-readable program according to claim 17 is stored.
